(19) United States
(12) Patent Application Publication
(10) Pub. No.: US 2024/0211586 A1
(43) Pub. Date: Jun. 27, 2024

(54) PROMPTING DATA SESSION

(71) Applicant: INTERNATIONAL BUSINESS MACHINES CORPORATION, Armonk, NY (US)

(72) Inventors: Harish BHARTI, PUNE (IN); Pinaki BHATTACHARYA, PUNE (IN); Sandeep SUKHIJA, RAJASTHAN (IN); Dinesh WADEKAR, PUNE (IN); Simmi GUPTA, GHAZIABAD (IN); Rajesh Kumar SAXENA, THANE EAST (IN)

(21) Appl. No.: 18/146,146

(22) Filed: Dec. 23, 2022

(51) Int. Cl. G06F 21/51

(52) U.S. Cl. CPC G06F 21/51; G06F 2221/033

(57) ABSTRACT

Methods, computer program products, and systems are presented. The method computer program products, and systems can include, for instance: examining user data of at least one user to determine whether a criterion has been satisfied for running a prompting data session for prompting the at least one user; responsively to determining that the criterion has been satisfied for running the prompting data session for prompting the at least one user, running a prompting data session, wherein the running the prompting data session includes (a) establishing and iteratively updating a relationship graph and (b) presenting the iteratively updated relationship graph to one or more user.

### BACKGROUND

Embodiments herein relate generally to presentment of prompting data and specifically to presentment of prompting data to a user, wherein prompting data can be iteratively updated and/or adapted.

Data structures have been employed for improving operation of computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: examining user data of at least one user to determine whether a criterion has been satisfied for running a prompting data session for prompting the at least one user; responsively to determining that the criterion has been satisfied for running the prompting data session for prompting the at least one user, running a prompting data session, wherein the running the prompting data session includes (a) establishing and iteratively updating a relationship graph and (b) presenting the iteratively updated relationship graph to one or more user.

In another aspect, a computer program product can be provided. The computer program product can include a computer readable storage medium readable by one or more processing circuit and storing instructions for execution by one or more processor for performing a method. The method can include, for example: examining user data of at least one user to determine whether a criterion has been satisfied for running a prompting data session for prompting the at least one user; responsively to determining that the criterion has been satisfied for running the prompting data session for prompting the at least one user, running a prompting data session, wherein the running the prompting data session includes (a) establishing and iteratively updating a relationship graph and (b) presenting the iteratively updated relationship graph to one or more user.

In a further aspect, a system can be provided. The system can include, for example a memory. In addition, the system can include one or more processor in communication with the memory. Further, the system can include program instructions executable by the one or more processor via the memory to perform a method. The method can include, for example: examining user data of at least one user to determine whether a criterion has been satisfied for running a prompting data session for prompting the at least one user; responsively to determining that the criterion has been satisfied for running the prompting data session for prompting the at least one user, running a prompting data session, wherein the running the prompting data session includes (a) establishing and iteratively updating a relationship graph and (b) presenting the iteratively updated relationship graph to one or more user.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, client computer systems, UE devices, social media system and publication system according to one embodiment;

FIG. 2 is a flowchart illustrating a method for performance by manager system interoperating with UE devices, a social media system and a publication system according to one embodiment;

FIG. 3A depicts a predictive model trained by machine learning according to one embodiment;

FIG. 3B depicts a predictive model trained by machine learning according to one embodiment;

FIG. 4 is a diagram illustrating identification of related assets using clustering analysis for generation of a relationship graph according to one embodiment;

FIG. 5 illustrates dynamically changing presented relationship graphs presented differently to first and second users according to one embodiment;

FIG. 6A-6C is a flowchart illustrating performance of a method for presenting prompting data according to one embodiment;

FIG. 7A-7B is a flowchart illustrating a method for presenting prompting data according to one embodiment;

FIG. 8A is a flowchart illustrating a method for presenting prompting data according to one embodiment;

FIG. 8B is a flowchart illustrating a method for performance of presenting prompting data according to one embodiment;

FIG. 8C is a flowchart illustrating a method for performance of presenting prompting data according to one embodiment;

FIG. 8D is a flowchart illustrating a method for performance of presenting prompting data according to one embodiment;

FIG. 9 depicts a relationship graph (mind map) according to one embodiment;

FIG. 10 is a flowchart illustrating a method for performance of presenting prompting data according to one embodiment;

FIG. 11 depicts a computing environment according to one embodiment;

### DETAILED DESCRIPTION

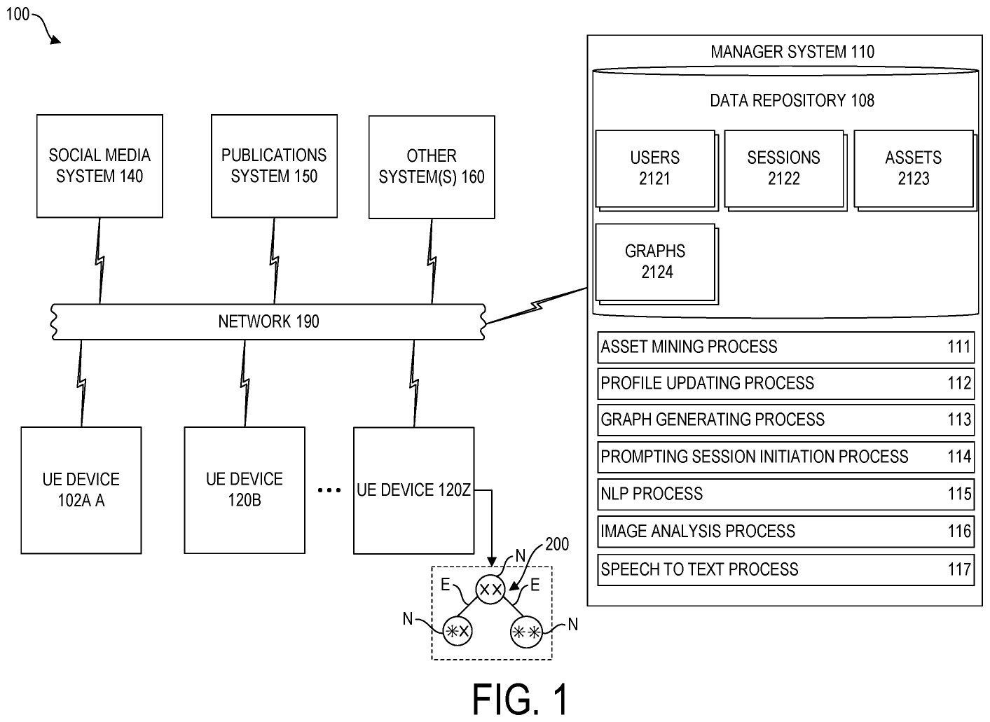

System 100 for use in presenting prompting data to one or more user is shown in FIG. 1. System 100 can include manager system 110 having an associated data repository 108, a plurality of user equipment (UE) devices 120A-120Z, social media system 140, publication system 150, and other systems 160. Manager system 110, UE devices 120A-120Z, social media system 140, publication system 150, and other systems 160 can be in communication with one another via network 190. System 100 can include numerous devices which can be computing node-based devices connected by network 190. Network 190 can include a physical network and/or virtual network. Physical network can be, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network.

According to one embodiment, manager system 110 can be external to UE devices 120A-120Z, social media system 140, publication system 150, and other systems 160. According to one embodiment, manager system 110 can be co-located with one or more of UE devices 120A-120Z, social media system 140, publication system 150, and/or other systems 160.

Manager system 110 can be configured to present prompting data to one or more user. The prompting data, in one embodiment, can include a relationship graph 200. Relationship graph 200 as shown in FIG. 1 can include nodes N and edges E. Edges can be between nodes that are related to one another, and edges can include attributes that indicate a relationship between nodes. Nodes can display asset data of data assets herein. Data assets herein can include, for presentment to a user, text as indicated by double Xs “XX”, graphics indicated by double asterisks **, or combined text and graphics indicated by an X in combination with an asterisk *. In one aspect, a relationship graph 200 herein can define prompting data in respect to one or more topic. In one aspect, relationship graph 200 herein can include nodes and edges. A presented node herein can present data on a data asset.

Nodes of a relationship graph 200 herein can be associated to, and can present data, on respective data assets. In one aspect of a relationship graph 200 herein, (also termed a mind map), can present information on one or more topic.

A relationship graph 200 herein can include edges that connect various nodes of a relationship graph 200 wherein the various nodes map and are associated to respective data assets which data asset can include, e.g., text data assets and/or graphics data assets.

In one aspect, a relationship graph 200 herein presented to a user can define prompting data. The prompting data defined by a relationship graph 200 (mind map) can, e.g., prompt the user to engage by reading and/or viewing one or more asset defining a relationship graph 200. The prompting data can further prompt the user to take further action, e.g., contribute to an ongoing text and/or voice conversation of a current session, perform online research or take particular action in respect to the current user interface presented to a user. One embodiment, a relationship graph 200 herein defining prompting data, can serve as conversation facilitators.

In one use case, conversation between two or more users can be detected. On the detection of a conversation, one or more topic defining a conversation can be extracted. With a topic extracted for a conversation, a relationship graph 200 with the topic can be established and the relationship graph 200 for the topic can be adapted differently for the different users associated to the conversation such that the different users associated to a conversation can be presented different adaptations (versions) of a common relationship graph 200. In the conversation, the adapted relationship presented to each user can be updated. Thus, the user can be presented real-time prompting data defined by relationship graph 200 that is constantly updated in real-time in dependence on changing attributes of the current conversation.

Data repository 108 can store various data. In users area 2121, data repository 108 can store data on users of system 100. Users can include registered users and/or guest users. On registration of a user in the system 100, manager system 110 can associate to each user a universal unique identifier (UUID). In users area 2121, there can be stored for respective users of system 100 and manager system 110, various user data. User data can include, e.g., the described UUID and profile data. Profile data for a user can include, e.g., preference data and/or demographic data. User profile data can include preference data as set forth herein and/or demographics data. Preference data can include, e.g., topics of interest to a user and sentiment associated to such data. Demographics data of a user can include, e.g., knowledge level, geographical address, and languages spoken. In one aspect, registration data can include profile data. In one aspect, manager system 110 can examine data, e.g., of social media system 140, publications system 150, other systems 160, and/or sessions area 2122 for extraction of profile data including preference data and/or demographic data. Manager system 110 determining profile data can include manager system 110 subjecting user content to natural language processing. User content can include, e.g., session data conversation content of a user, submitted registration data of a user, social media content of a user, and message data content of a user. Manager system 110 can use profile data of a user to establish and/or adapt relationship graph 200 for presentment to the user.

In sessions area 2122, data repository 108 can store data on prompting data sessions mediated and managed by manager system 110. Sessions area 2122 can store historical data respecting prompting data sessions mediated and managed by manager system 110, in which manager system 110 has presented a relationship graph 200 to one or more user of system 100. Session data can include, e.g., historical relationship graphs 200 that have been presented to various users, timestamps associated to such relationship graphs 200 indicating the time of presentment of such relationship graph, the type of relationship graph presented, e.g., baseline relationship graph 200 or adapted relationship graph 200, and feedback data associated to presented relationship graph 200.

Feedback data can include data that specifies engagement actions of a user with respect to a relationship graph 200. A relationship graph 200 herein can be presented with active areas; which, when actuated by a user can present additional, e.g., often more detailed data, to a user. An active area can include, e.g., hyperlink text or hyperlink graphics which are hyperlinked to a new presentation area (e.g., webpage or popup) which can be presented to a user upon actuation. In one aspect, manager system 110 can examine feedback data to determine an historical level of engagement of a user with the relationship graph 200.

Data repository 108 in assets area 2123 can store data assets for association to a node of one or more relationship graph 200 presented by manager system 110. Data assets herein can include text asset data and/or graphics asset data.

As set forth herein, manager system 110 can be configured to iteratively mine various data sources such as social media system 140, publication system 150, and other systems 160 for data assets stored in assets area 2123 for inclusion in relationship graphs 200 that are generated by manager system 110.

Manager system 110 in graphs area 2124 can store relationship graphs 200 for presentment by manager system 110 in prompting data sessions mediated by manager system 110. Relationship graphs 200 (mind maps) herein can include nodes for presentment of asset data and edges connecting various ones of the described nodes. In one aspect, manager system 110 can generate relationship graph 200 for storage in graphs area 2124 in the background, independent of any initiation of a prompting data session in which prompting data presenting a relationship graph 200 is presented to a user. In such use case, relationship graph 200 can be pre-formed prior to a prompting data session so that they are ready to go on an as-needed basis in the initiation of a prompting data session. In one aspect, manager system 110 can be configured to generate a relationship graph 200 for presenting to a user in response to the initiation of a prompting data session in which the generated relationship graph 200 (possibly adapted) is presented to a user.

Manager system 110 can run various processes. Manager system 110 can run asset mining process 111, profile updating process 112, graph generating process 113, prompting session initiation process 114, natural language processing (NLP) process 115, image analysis process 116, and speech to text process 117.

Manager system 110 running asset mining process 111 can include manager system 110 mining data assets. Assets mined by manager system 110 running asset mining process 111 can include, e.g., text assets, graphics assets, combined graphics, and text assets. Manager system 110 running asset mining process 111 can include manager system 110 iteratively extracting data assets from social media system 140, publication system 150, and/or other systems 160.

Social media system 140 and publication system 150 can be representative of one or more social media system or publication system. Social media system 140 can include a collection of files, including for example, HTML files, CSS files, image files, and JavaScript files. Social media system 140 can be a social website such as FACEBOOK® (Facebook is a registered trademark of Facebook, Inc.), TWITTER® (Twitter is a registered trademark of Twitter, Inc.), LINKEDIN® (LinkedIn is a registered trademark of LinkedIn Corporation), or INSTAGRAM® (Instagram is a registered trademark of Instagram, LLC). Computer implemented social networks incorporate messaging systems that are capable of receiving and transmitting messages to client computers (UE devices) of participant users of the messaging systems. Messaging systems can also be incorporated in systems that that have minimal or no social network attributes. A messaging system can be provided by a short message system (SMS) text message delivery service of a mobile phone cellular network provider or an email delivery system. Manager system 110 can include a messaging system, in one embodiment.

During a process of registration wherein a user of system 100 registers as a registered user of system 100, a user sending registration data can send, with permission data defining the registration data, a permission that grants access by manager system 110 to data of the user within social media system 140. On being registered, manager system 110 can examine data of social media system 140 e.g., to determine whether first and second users are in communication with one another via a messaging system of social media system 140. A user can enter registration data using a user interface displayed on a UE device of UE devices 120A-120Z.

Entered registration data can include e.g., name, address, social media account information, other contact information, biographical information, background information, preferences information, and/or permissions data e.g., can include permissions data allowing manager system 110 to query data of a social media account of a user provided by social media system 140 including messaging system data and any other data of the user. When a user opts-in to register into system 100 and grants system 100 permission to access data of social media system 140, system 100 can inform the user as to what data is collected and why, that any collected personal data may be encrypted, that the user can opt out at any time, and that if the user opts out, any personal data of the user is deleted.

Publications system 150 can be a system that stores publications, e.g., documents, technical journals, product specifications, technical specifications, articles, dictionaries, including technical dictionaries, and the like.

Manager system 110 running asset mining process 111 can include manager system 110 running NLP process 115 set forth in further detail herein. Manager system 110 running asset mining process, in another aspect, can include manager system 110 running a graphics to text process to extract text based tags from graphics, e.g., photographs or drawings.

Manager system 110 can be configured so that when manager system 110 extracts a graphic e.g., a photograph or drawing, manager system 110 can run image analysis process 116 to subject graphics data to image analysis process 116 process for extracting text based tags including text based tags specifying topics from graphics. The image analysis process can define a graphic to text process. The graphic to text process can include image processing based topic extraction. Manager system 110 can activate an image analysis process to return topic classifiers of an image defined by a graphic.

Manager system 110 running asset mining process 111 can include manager system 110 mining various data sources, e.g., social media system 140 and publications system 150, and storing extracted assets in the assets area 2123 of data repository 108. Assets stored in assets area 2123 can include timestamps that specify the time that the respective asset was extracted from a data source. Asset data stored in assets area 2123 can be tagged with data tags in addition to timestamps. For example, as noted, extracted assets in the form of graphics can be subject to image analysis graphics to text processing for extraction of text based descriptive tags, including topic specifying tags associated to the graphic. These text based tags can be associated as part of the extracted data asset.

Asset data extracted from social media system 140 can include, e.g., posted photographs, drawings or text such as text provided by posts by users of social media system 140, and documents posted on social media system 140, including advertising documents. Extracted data assets can include text and/or graphics.

Manager system 110 running graph generating process 112 can generate relationship graph 200. Manager system 110 in one use case running graph generating process 113, can include manager system 110 generating relationship graph 200s (mind maps) defining prompting data in the background for subsequent presentment to users. In one example, manager system 110 can be iteratively generating a plurality of baseline relationship graph 200, the background for a plurality of topics for which prompting data is expected to be regularly invoked.

In another use case, manager system 110 running graph generating process 112 can include manager system 110 generating a relationship graph 200 responsively to the initiation of a prompting data session in which one or more user is presented prompting data defined by one or more relationship graph 200.

Manager system 110 running graph generating process 112 can include manager system 110 identifying a topic and manager system 110 identifying data assets having a threshold level of similarity with the topic. Manager system 110 identifying data assets having a threshold level of similarity with the topic can include manager system 110 identifying data assets having a threshold level of similarity with a topic definitional asset associated to the topic.

Assets stored in assets area 2123 can include topic definitional assets (which can be termed anchor assets). A topic definitional asset can include a keyword defining a topic and optionally can include a text descriptor of the topic. Topic definitional assets can be mined from data sources such as social media system 140, publications system 150 and other system 160 and/or can be authored by an administrator user. In one example, an administrator user can edit a mined data asset to provide a topic definition (anchor) asset.

In another use case, manager system 110 identifying a topic for a relationship graph 200 can include manager system 110 examining request data initiated by a user. The topic for relationship graph 200 identified by manager system 110 can examine data of assets area 2123 to identify a topic definitional asset (anchor asset) associated to the identified topic.

Manager system 110 running graph generating process 112 can include manager system 110 identifying a topic for a relationship graph 200 to be generated. In one example, manager system 110 identifying a topic for a relationship graph 200 can include manager system 110 subjecting text of a current conversation between users to natural language processing for extraction of the topic associated to the conversation. The current conversation can be text based or voice based. Where the current conversation is voice based, the conversation can be transformed into text and subject to natural language processing by natural language processing (NLP) process 115.

With the topic definitional asset for a topic identified, manager system 110 running graph generating process 113 can identify one or more assets from assets area 2123 having a threshold level of similarity to the identified topic definitional asset. For determining assets having a threshold level of similarity to the product definitional asset, manager system 110 running graph generating process 113 can employ clustering analysis. For performing clustering analysis, metrics for different data assets stored in assets area 2123 mined from one more data source can be considered across multiple dimensions. In one example, the multiple dimensions can include, e.g., (a) a term strength dimension, and (b) an engagement strength metric dimension. The engagement strength metric can refer to a user engagement strength metric. A generated relationship graph 200 can include nodes N and edges E as shown in FIG. 1. For generating a relationship graph 200, manager system 110 can present asset data of data assets within nodes N of relationship, and edges E can connect nodes N. One or more data assets identified as having a threshold similarity to the topic definitional asset can be edge connected to the topic definitional asset in the generated relationship graph 200. In one embodiment, manager system 110 can feature edges to include edge strengths that indicate the level of similarity between connected nodes. For example, in a displayed and presented relationship graph 200, a thickness of lines defining edges can be scaled in dependence on similarity level between asset data of respective nodes.

Manager system 110 running profile updating process 112 can include manager system 110 updating preferences of a user, e.g., topics of interest to a user and sentiments associated to such topics of interest to a user. Manager system 110 running profile updating process 112 can include manager system 110 updating demographic data of a user. Manager system 110 updating demographic data can include subjecting content of a user to extract linguistic complexity data of a user. Manager system 110 running profile updating process 112 can include manager system 110 updating node engagement preferences of a user.

Manager system 110 running prompting session initiation process 113 can include manager system 110 identifying the satisfaction of one or more criterion for the initiation of a prompting data session in which a relationship graph 200 can be presented to one or more user.

In one aspect, manager system 110 can be configured to passively initiate a prompting session, e.g., under the circumstance that two or more users are engaged in a conversation, e.g., voice based or text based and one or more topic has been identified from the conversation. In another example, manager system 110 running prompting session initiation process can receive and examine request data from a user requesting prompting data be presented to the user.

Manager system 110 running natural language processing (NLP) process 115 can include manager system examining text for extraction of NLP parameters. Manager system 110 can run NLP process 115 to process data for preparation of records that are stored in data repository 108 and for other purposes. Manager system 110 can run a natural language processing (NLP) process 113 for determining one or more NLP output parameter of a message. NLP process 115 can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters e.g., one of more “social tendency” NLP output parameter or one or more “writing style” NLP output parameter.

By running of NLP process 115, manager system 110 can perform a number of processes including one or more of (a) topic classification and output of one or more topic NLP output parameter for a received message, (b) sentiment classification and output of one or more sentiment NLP output parameter for a received message, or (c) other NLP classifications and output of one or more other NLP output parameter for the received message.

Topic analysis for topic classification and output of NLP output parameters can include topic segmentation to identify several topics within a message. Topic analysis can apply a variety of technologies e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment, sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust,” “fear,” “joy,” and “sadness.”

Manager system 110 running NLP process 115 can include manager system 110 returning NLP output parameters in addition to those specifying topic and sentiment, e.g., can provide sentence segmentation tags and part of speech tags. Manager system 110 can use sentence segmentation parameters to determine, e.g., that an action topic and an entity topic are referenced in a common sentence, for example.

In one aspect, manager system 110 running NLP process 115 can include manager system 110 extracting a linguistic complexity level parameter value from text data defining an asset or other text data. For extracting linguistic complexity parameter values, manager system 110 can tokenize text (e.g., originally authored text or text converted from voice). Tokenizing text can include breaking sentences of an asset into separate words (tokens), removing punctuation, symbols, numbers, and transforming to lowercase. With an asset tokenized, manager system 110 can examine the tokenized text to ascertain textual richness. In one example, manager system 110 can perform a type-token ration (TTR) analysis. Performing TTR analysis can include calculating a number of unique words in an asset divided by the number of tokens. The higher the TTR, the higher the lexical complexity. Linguistic complexity can additionally or alternatively be determined using Hapax richness analysis. Performing Hapax richness analysis can include identifying words that occur only once within an asset, ascertaining a count of such single instance words, and finding a proportion of single instance words to an overall count of tokens in an asset.

Manager system 110 running NLP process 115 can include manager system 110 examining asset data of assets area 2123 or can include manager system 110 examining text defining a current conversation, e.g., for identification of a topic of a conversation, which identification can satisfy criterion for initiation of a prompting session in which one or more user is presented with the relationship graph 200.

Manager system 110 running image analysis process 116 can include manager system 110 extracting text based data from graphics. Manager system 110 can run image analysis process 116 to subject graphics data to image analysis process 116 process for extracting text based tags including text based tags specifying topics from graphics. The image analysis process can define a graphic to text process. The graphic to text process can include image processing based topic extraction. Manager system 110 can activate image analysis process to return topic classifiers of an image defined by a graphic. The topic tags can be accompanied by levels of confidence. In one embodiment, an image analysis service can be provided by IBM Watson® Visual Recognition Services (IBM Watson is a registered trademark of International Business Machines Corporation). In one example, subjecting a graphic depicting a jewelry item might yield the following topic classifications: necklace (confidence score 0.73), bracteole (confidence score 0.72), ivory color (confidence score 0.61), and bling (confidence score 0.55). Manager system 110 can further return markup language content specifying the various topic classifications and confidence levels. The returned topic specifying text can be incorporated in the data asset as asset data text. Text of a data asset can include (i) presented text for presentment to a user and (ii) text that serves as asset metadata that is not presented to a user. Both text of type (i) and (ii) can be subject to natural language processing, e.g., for topic extraction, term strength parameter value extraction, and/or linguistic complexity parameter value extraction.

Manager system 110 running speech to text process 117 can include manager system 110 converting speech (voice based data) into text based data. Subsequent to conversion of speech to text, manager system 110 can subject the return text to processing by NLP process 115 for extraction of NLP parameters, e.g., topic identifiers or linguistic complexity parameter values.

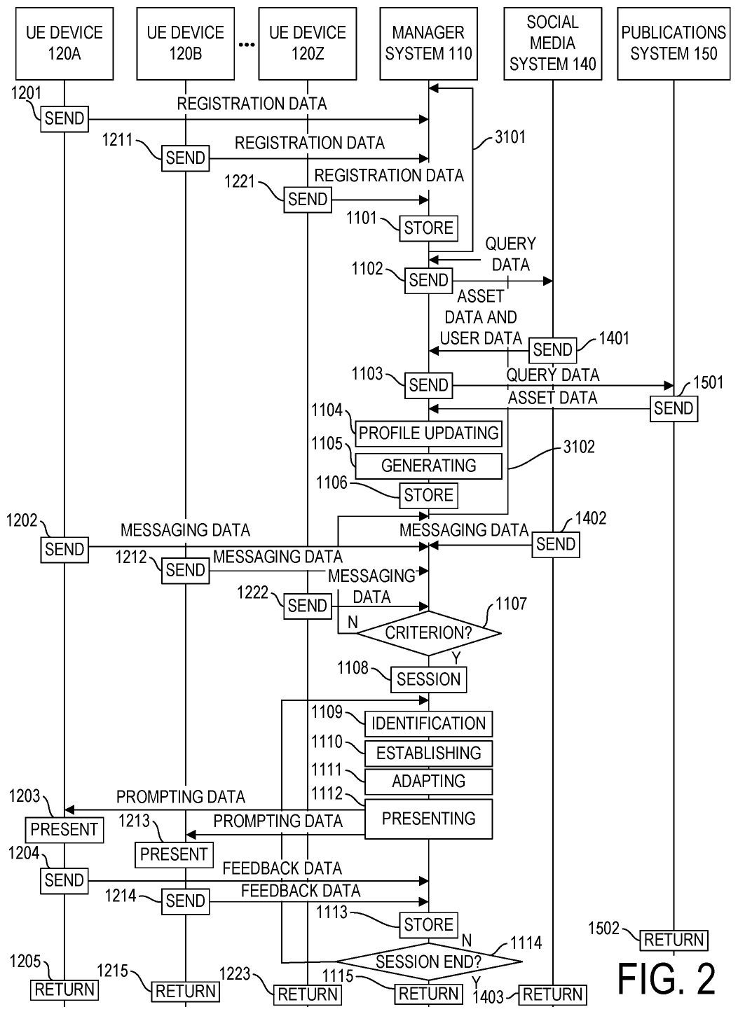

A method for performance by manager system 110 interoperating with UE devices 120A-120Z, social media system 140, and publication system 150 is set forth in reference to the flowchart of FIG. 2. At blocks 1201, 1211 and 1221, UE devices 120A-120Z can be sending registration data for receipt and storage by manager system 110. On receipt by manager system 110 of the described registration data, manager system 110 at block 1101 can store the received registration data. Registration data can include, e.g., contact information, demographic information, preference information, and permissions data. Contact data can include, e.g., name, address, including physical address and electronic messaging system, e.g., social media and email addresses. Demographic data can include, e.g., date of birth, geography, e.g., home address, business address, current location, and knowledge level. In embodiments herein, a user can report educational level, e.g., high school, college, advanced degree, etc., and manager system can use such reported data in determining knowledge level across different topic domains. In one embodiment, determining a knowledge level of a user can include subjecting assets of the user, e.g., authored text of a user or text converted from speech, to natural language processing linguistic complexity analysis for extraction of a parameter value specifying linguistic complexity capability of a user. Knowledge level can be determined on a per topic basis.

Preference data can include, e.g., topics of interest reported by user and sentiment associated to such topics of interest. Preferences as set forth herein, can be determined by examination of reported data reported with registration data set forth herein and/or can be determined by way of examination of user data (such a social media posts data and/or session conversation data), e.g., with use of topic extraction and/or sentiment analysis with natural language processing.

Permissions data of a user can include, e.g., permissions by user to use user data such as user data associated with the user's account on social media system 140. On receipt and storage of registration data at block 1101, manager system 110 can assign a user a UUID and can store in users area 2121 of data repository 108 the registration data and various other user data.

In response to storage of registration data at block 1101, manager system 110 can advance to blocks 1102 and 1103. At blocks 1102 and 1103, manager system 110 can send query data to social media system 140 and publications system 150.

At block 1102, manager system 110 can send query data to social media system 140 for return of asset data and user data. In response to a received query data, social media system 140 can send at block 1401 asset data and user data to manager system 110. Asset data can include data defining data assets as set forth herein and user data can be data of the user, e.g., posts data and the like posted on social media system 140.

At block 1103, manager system 110 can send query data to publications system 150 for return of asset data. In response to the received query data sent at block 1103 publication system 150 at block 1501 can send asset data to manager system 110. The asset data can be data defining data assets herein, e.g., text based, graphic based, or text and graphics based data. In some use cases, user data can also be returned at block 1501, e.g., including a document posted on publications system 150 was authored by a user of system 100.

In response to the received asset data and user data sent at blocks 1401 and blocks 1501, manager system 110 can perform profile updating at block 1104 and relationship graph generating at block 1105. Referring to block 1104, manager system 110 can perform profile updating in response to received user data sent at blocks 1401 and/or block 1501.

Embodiments herein recognize that user profile data can include preference data as set forth herein and/or demographics data. Preference data can include, e.g., topics of interest to a user and sentiment associated to such data. Demographics data of a user can include, e.g., knowledge level, geographical home address, and/or languages spoken. Manager system 110 determining profile data can include manager system 110 subjecting asset data of a user to natural language processing. Asset data of a user can include, e.g., session data conversation content of a user, submitted registration data of a user, social media content of a user, or conversation data content of a user. Manager system 110 can use profile data of a user to establish and/or adapt relationship graphs 200 for presentment to a user.

User demographic data can include user knowledge level data. According to aspects set forth herein, manager system 110 can be configured to ascertain a user's knowledge level by subjecting asset data of a user, e.g., text based content and/or voice based content to natural language processing. Asset data of a user can be subject to natural language processing to extract a linguistic complexity parameter value associated to asset data of a user. Asset data of a user include text based data, e.g., text based data originally authored in text by a user or text based data derived by subjecting voice based data of a user to speech-to-text conversion for providing text content based on voice content of the user. The text based content, i.e., either original text or text derived from voice can be subject to text based natural language processing by running of natural language processing (NLP) process 115 as set forth herein. Asset data of a user can include, e.g., social media posts including text and/or photographs, documents, e.g., published papers, and session data, e.g., text-based conversation content (e.g., original text based content or converted from voice). A certain asset of a user can be subject to natural language processing for extraction of a topic parameter value and linguistic complexity parameter value, and results can be aggregated on a per topic basis to return parameter values specifying a user's linguistic complexity capability across a variety of topics. In one embodiment, aggregating results can include application of results data for training on a predictive model.

Manager system 110 performing profile updating block 1104 can include manager system 110 updating preferences of a user, e.g., topics of interest to a user and sentiments associated to such topics of interest to a user. Manager system 110 performing profile updating at block 1104 can include manager system 110 updating demographic data of a user. Manager system 110 updating demographic data can include subjecting content of a user to extract linguistic complexity data of a user.

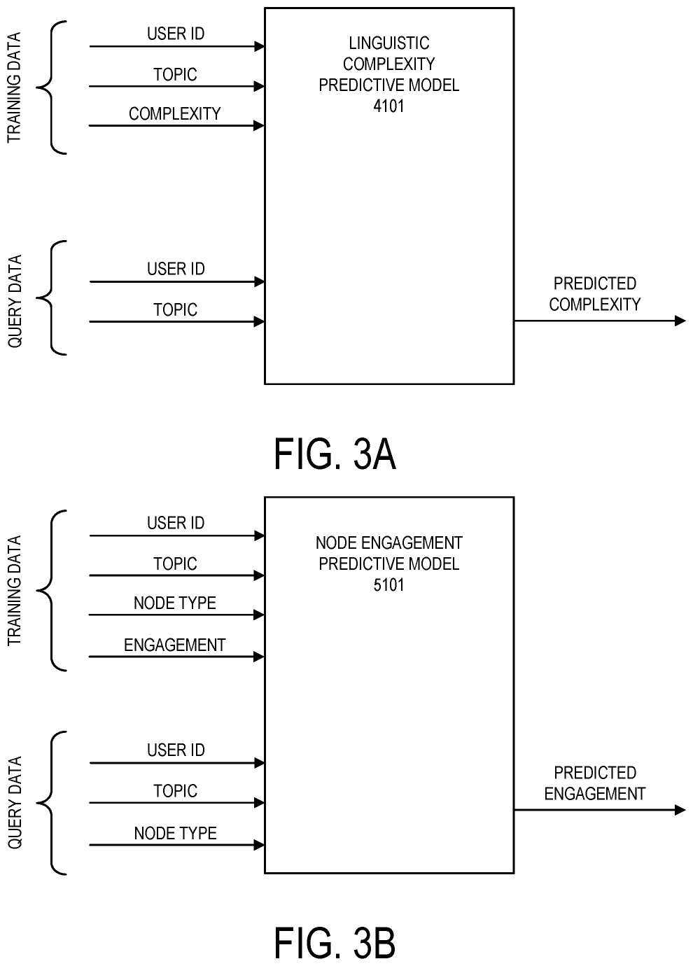

Manager system 110 performing profile updating at block 1104 can include manager system 110 training linguistic complexity predictive model 4101. In one use case, manager system 110 performing profile updating at block 1104 can include manager system 110 updating predictive model 4101 as set forth in FIG. 3A. Linguistic complexity predictive model 4101 can be a predictive model for predicting linguistic complexity of user content based on topic of the content. The complexity metric can be used as a measure of knowledge level of a user as set forth herein. Linguistic complexity predictive model 4101 can be trained with iterations of training data and, once trained, linguistic complexity predictive model 4101 is able to respond to query data. Iterations of training data for training linguistic complexity predictive model 4101 can include data tags associated asset data of a user. Asset data of a user can include, e.g., social media posts including text and/or photographs, documents, e.g., published papers, and session data, e.g., text-based conversation content (e.g., original text based content or converted from voice) during a prompting data session in which the user is presented with prompting data defined by a relationship graph 200 as set forth herein. Thus, at profile updating step block 1104, manager system 110 can use user data sent at block 1401 and possibly block 1501, as well as sessions data of a most recent prompting session in which a user participates and in which the user is presented a relationship graph 200 as set forth herein.

With reference to linguistic complexity predictive model 4101, iterations of training data can include a dataset comprising: (a) user ID; (b) topic; and (c) linguistic complexity level of a message derived by subjecting the message to natural language processing and outputting a linguistic complexity parameter value. Linguistic complexity predictive model 4101, once trained, is able to respond to query data. Query data for querying linguistic complexity predictive model 4101 can include user ID identifying the user and a current topic. On presentment of the query data as set forth in FIG. 3A, linguistic complexity predictive model 4101 can output a predicted complexity of content of the user associated to the topic specified with the query data. Thus, linguistic complexity predictive model 4101, once trained, is able to provide prediction as to the complexity of the user in reference to any given topic. Upon completion of profile updating at block 1104, manager system 110 can proceed to block 1105.

At block 1105, manager system 110 can perform generating of one or more relationship graph 200 for one or more topic. According to one use case, manager system 110 can be configured to iteratively produce baseline relationship graph 200s for a plurality of major topics regularly invoked by customer users of the service provided by manager system 110. Thus, on the later initiation of a prompting data session in which a user is presented with a prompting relationship graph 200, a relationship graph 200 for supporting the prompting data session can be premade and ready for use without delay. A generated relationship graph 200 can include a node for presentment of a term definitional asset, and one or mode additional nodes for presentment of data assets determined to have threshold similarity with a term definitional asset.

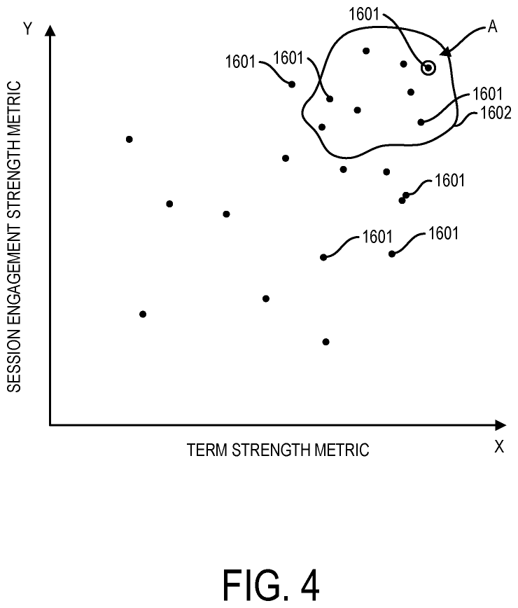

A method for generation of a relationship graph 200 using unsupervised machine learning clustering analysis is shown in FIG. 4. In FIG. 4, there are plotted in X-Y dimensional space a plurality of vectors 1601, where each vector 1601 represents a different asset stored in asset area 2123 of data repository 108. Manager system 110 can be configured to perform clustering analysis for the generating of relationship graph 200. Vectors 1601 as shown in FIG. 4 can be vectors representing various assets as set forth herein, including data assets having text, data assets having graphics, and data assets having combined text and graphics. Vector 1601 at A can be a vector for a definitional asset (anchor asset) referring to the clustering analysis diagram of FIG. 4.

Data assets stored in assets area 2123 can be plotted by manager system 110 in first and second dimensions referring to the clustering analysis diagram of FIG. 4. A first dimension (X-dimension) can be a term strength metric dimension for a certain topic, and the second dimension (Y-dimension) can be a session engagement strength metric dimension for the certain topic, according to one example. For the term strength metric dimension, manager system 110 can examine terms (e.g., including words) defining an asset. For the term strength dimension as set forth in FIG. 4, manager system 110 can evaluate an assets usage of terms that define the certain topic. In one aspect, a topic herein can be defined by a domain of words, e.g., bag of words where usage of the words is indicative of a topic being presented. In one example, there can be associated to each topic having an associated term definitional data asset, a certain bag of words, and term strength of various other candidate data assets can be determined with reference to the certain bag of words. Term strength metric can be assigned based on usage of different terms that define the presence of the certain topic. Various term strength parameters can be utilized, e.g., term frequency or term frequency inverse document frequency (TDIF). In one example, the certain topic for the term definitional data asset as set forth in FIG. 2B can be an identified topic triggering a prompting data session. Manager system 110, in one example, can perform the analysis depicted in FIG. 4 for a library of common topics that are specified by an administrator user.

For the session engagement strength metric, manager system 110 can assign the session engagement strength metric based on engagement of the particular data asset by historical users of system 100 when the historical data asset is presented with term definitional asset for the certain topic. In sessions area 2122, there can be stored data specifying user engagement activities with a presented asset wherein the presented asset is presented as part of a relationship graph 200 presented to a user having a certain topic definitional node for the certain topic.

Manager system 110 can assign engagement scores for an asset in dependence on user engagement with the asset being displayed on a relationship graph 200 having a certain topic definitional node. Various activities of a user can result in increased engagement scores that are assigned to a data asset. Where an asset is an active asset (e.g., having a hyperlink), the user can actuate the active asset. Such actuations can increase an engagement score that manager system 110 assigns to a data asset for performance of clustering analysis as depicted in FIG. 4. Manager system 110 can also assign engagement scores to an asset in dependence on how quickly an asset is actuated after being displayed on a display of a UE device and/or the force with which the user actuates a presented asset. Manager system 110 can assign an engagement score for an asset (above baseline threshold) where a user actuates an asset more quickly (prior to a baseline threshold time) after it is presented. Manager system 110 can also assign engagement scores for an asset (higher than a baseline threshold score) where the user actuates an asset more forcefully (above a baseline threshold force). For example, a displayed user interface can have a Z-direction force sensor and manager system 110 can increase an engagement score in dependence on how forcefully a user engages a presented asset on display of the asset. Manager system 110 can also assign engagement scores for an asset in dependence on an eye gaze of a user on asset data presented in a relationship graph 200.

Manager system 110 can also assign engagement scores to an asset in dependence on whether a user which references the asset is presented content of a user during a current session after presentment of an asset in a relationship graph 200 having a topic definition node in common with a current topic definition.

Manager system 110 after presentment of an asset in a relationship graph 200 can monitor presented content, e.g., text-based content or voice converted into a text for text strings matching the text string of a presented asset. The presence of referenced text strings in presented content can increase an engagement score that the manager system 110 attaches to a given asset. Manager system 110, in providing an engagement score for an asset, can examine historical data in which the asset was presented in a relationship graph 200 that presents a definitional asset for a given topic.

Manager system 110 can employ the formula of Eq. 1 for assigning engagement scores to a current asset.

$$S = F 1 W 1 + F 2 W 2 + F 3 W 3 + F 4 W 4 + F 5 W 5 \qquad ( Eq . 1 )$$

Where F1 through F5 are factors and W1 through W5 are weights associated to the various factors. Manager system 110 employing Eq. 1 can include manager system 110 examining historical data in which an asset for consideration was presented in a relationship graph 200 presenting a topic definitional data asset for the current topic being evaluated.

According to Eq. 1, F1 can be an asset actuation factor. Manager system 110 can assign a higher than baseline score, according to factor F1, when the asset was actuated during the historical session and can assign a lower than baseline value, according to factor F1, where the asset was not actuated during the historical prompting session. Factor F2 can be a speed of engagement factor. Manager system 110 can assign a higher than baseline value, under factor F2, where the asset was actuated within a threshold period of time and can assign a lower than baseline value, under factor F2, where the asset was actuated in a time frame beyond the threshold period of time. Factor F3 can be a force of actuation factor. Manager system 110 can assign a higher than baseline value, under factor F3, for an asset when the asset was actuated with greater than a threshold level of force and can assign a lower than baseline value, under factor F3, where the asset during the historical session was actuated with less than the threshold amount of force. Factor F4 can be a referenced factor. Manager system 110, under factor F4, can assign a greater than baseline value, under factor F4, where the asset was referenced during the historical session and can assign less than a baseline value, under factor F4, engagement strength value, under factor F4, where the asset was not referenced in content by users during the historical sessions. Results of applying factors F1 to F4 can be aggregated for all users. Factor F5 can be a gaze factor. Manager system 110 can scale assigned scoring values under factor F5 in accordance with a level of eye gaze on presented asset data during a prompting data session. Eye gaze can be tracked with use of a camera and eye gaze tracking software incorporated into a UE device of a user.

With vectors 1601 plotted for a comprehensive set of assets stored in assets area 2123, manager system 110 can select an asset for inclusion in a current relationship graph 200 being generated. In one use case, manager system 110 at generating block 1105 can select N nearest neighbor assets for inclusion in a current relationship graph 200. Referring to FIG. 4, there is shown cluster 1602 of assets defined by representative vectors 1601. Where the assets for inclusion in cluster 1602 can be selected based on closest Euclidean distance to the vector 1601 at A representing the topic definitional asset for a certain topic.

As indicated by loop 3102 of FIG. 2, the process of iteratively obtaining social media system data, publication system data, profile updating, and relationship graph 200 generating can be iteratively performed during a deployment period of system 100. That is, blocks 1102 to 1106 can be iteratively performed during a deployment period of system 100. Likewise, manager system 110 as indicated by loop 3101 can iteratively receive updated registration data from users for storage during a deployment period of system 100 and manager system 110.

At criterion block 1107, manager system 110 can determine whether one or more criterion for initiation of a prompting data session has been initiated. In one use case, manager system 110 can initiate a prompting data session passively without the user expressly invoking the prompting data session. In another use case, manager system 110 can initiate a prompting data session in response to an express request initiated by one or more user to initiate the prompting data session, e.g., a request by a user for prompting data regarding a specified topic. Request data from a user can be sent as message data from a user as indicated at block 1202, 1212, 1222 and/or can be sent via a messaging system (e.g., which can be incorporated in a social media system) as indicated by send block 1402. A prompting data session herein can be characterized by manager system 110 presenting to one or more user prompting data defined by one or more relationship graph 200. The one or more relationship graph 200 can present data respecting one or more topic. The relationship graph 200 defining prompting data can include one or more node that presents data respecting one or more topic. The one or more respective nodes of a relationship graph 200 can respectively present asset data of a data asset. In one embodiment, one particular node of a relationship graph 200 can present asset date data of a topic definitional asset. Data of other assets can be presented in nodes external to the asset definition node.

Nodes of the relationship graph 200 can be connected with edges that indicate the first and second nodes of the relationship graph 200 are related.

In response to one or more criterion for initiating a prompting data session being satisfied, manager system 110 can proceed to session block 1108. At session block 1108, manager system 110 can initiate a prompting data session characterized by one or more relationship graph 200 being presented to one or more user.

Blocks 1108, 1109, 1110, 1111, 1112, 1113, and 1114 specify prompting data session blocks in which manager system 110 presents prompting data defined by one or more relationship graph 200 to one or more user. At block 1109, manager system 110 can ascertain identifiers, e.g., UUIDs, for one or more user associated to a current prompting data session. At establishing block 1110, manager system 110 can establish a relationship graph 200 for use as prompting data for presentment in a current prompting data session. The establishing at block 1110 can include establishing a baseline relationship graph 200 which is later adapted for presentment differently to different users. At adapting block 1111, manager system 110 can adapt the relationship graph 200 established at block 1110 for presentment differently for different one or more users. At presenting block 1112, manager system 110 can present an adapted relationship graph 200 to one or more user. At presenting block 1112, manager system 110 can send prompting data defining a relationship graph 200 to UE devices 120A-120B of first and second users wherein relationship graph 200 can be adapted differently for the first and second users. On receipt of the prompting data, UE devices 120A-120B can display the respective prompting data on their respective displays. At return block 1115, manager system 110 can return to a stage prior to block 1107 to continue monitoring for satisfaction of a criterion triggering a prompting data session. As indicated by return blocks 1205, 1215, 1223, 1115, 1403, and 1502 it can be seen that functions described with reference to UE devices 120A-120Z, manager system 110, social media system 140 can be iteratively performed through a deployment period of system 100.

At store block 1113, manager system 110 can store received feedback data during a current prompting data session, wherein the feedback data is received from one or more user engaged with prompting data presented during the prompting data session. Feedback data can include, e.g., presented content from a user presented by one or more user. Content can include text based content of a voice based data presented by user. Text based data presented by a user can be text based data converted from voice data by running of speech to text process 117.

In one use case, manager system 110 at criterion block 1107 can ascertain whether two or more users are engaged in a conversation by monitoring messaging data sent by UE devices 120A-120Z at blocks 1202, 1212, and 1222 and/or by monitoring messaging data sent at block 1402 by a messaging system of social media system 140. In the scenario depicted in the flowchart of FIG. 2, manager system 110 at criterion block 1107 can ascertain that users of UE devices 120A and 120B are engaged in a conversation. The conversation can be supported by a messaging system, e.g., a messaging system of social media system 140 or another messaging system external to social media system 140. The described messaging system can be external to social media system 140, e.g., can be provided by an online videoconferencing system, an email system, or the like. The conversation detected at criterion block 1107 can be voice based or text based. If the conversation is voice based, manager system 110 can convert voice data to text data by running a speech to text process 117 (FIG. 1).

On the detection of a conversation at criterion block 1107, manager system 110 can subject all text of the conversation (originally authored text and/or text converted from voice) to natural language processing by running of NLP process 115. Subjecting text data of a conversation to natural language processing by NLP process 115 can include running NLP process 115 to extract one or more topic from the text based data defining a current conversation.

In one embodiment, manager system 110 on the detection of a topic by running of NLP process 115 can ascertain that criterion for establishing a prompting data session can be satisfied based on the topic being identified and then can proceed to session initiate block 1108. In some embodiments, manager system 110 initiating a session at block 1108 can be conditioned on additional criterion, in addition to identification of a topic. For example, in some embodiments, manager system 110 can proceed to session initiate block 1108 on the satisfaction of conditions that include (i) detection of a topic within conversation data, and (ii) independent evaluation of message data by each user. In other words, can be conditioned on extracting a certain topic by subjecting message data of a first user of a conversation to natural language processing and detection of the same topic independently by subjecting conversation message data of the second user participating in a conversation to natural language processing.

On the initiation of the current prompting data session at block 1108, manager system 110 can proceed to identification block 1109 to ascertain users of a prompting data session and then can proceed to block 1110 to perform establishing of a relationship graph 200 for presentment during a prompting data session. In one use case, manager system 110 for performing establishing at block 1110 can simply read a pre-generated relationship graph 200 from graphs area 2124 of data repository 108. As noted, manager system 110 at generating block 1105 can iteratively be generating a library of pre-generated relationship graph 200s for ready use on demand by users of system 100. Manager system 110, in another use case at block 1110 for establishing a relationship graph 200 for a newly initiated prompting data session, can perform generating of a relationship graph 200 for presentment of data respecting an identified topic identified at block 1107. Manager system 110 can perform generating a relationship graph 200 at establishing block 1110 rather than reading of a previously generated relationship graph 200 in the case, e.g., (a) that manager system 110 does not pre-generate any relationships graphs, (b) if the most recent relationship graph 200 for an identified topic identified at block 1107 is too aged, or (c) there is no relationship graph 200 for the particular topic identified at block 1107 that has triggered session initiate block 1108.

At establishing block 1110, manager system 110 can establish a relationship graph 200 for a topic identified at criterion block 1107 that has resulted in the current prompting data session being initiated at block 1108. The establishing at block 1110 can include establishing a baseline relationship graph 200 which baseline relationship graph 200 may be adapted differently for presentment to different users of a current conversation.

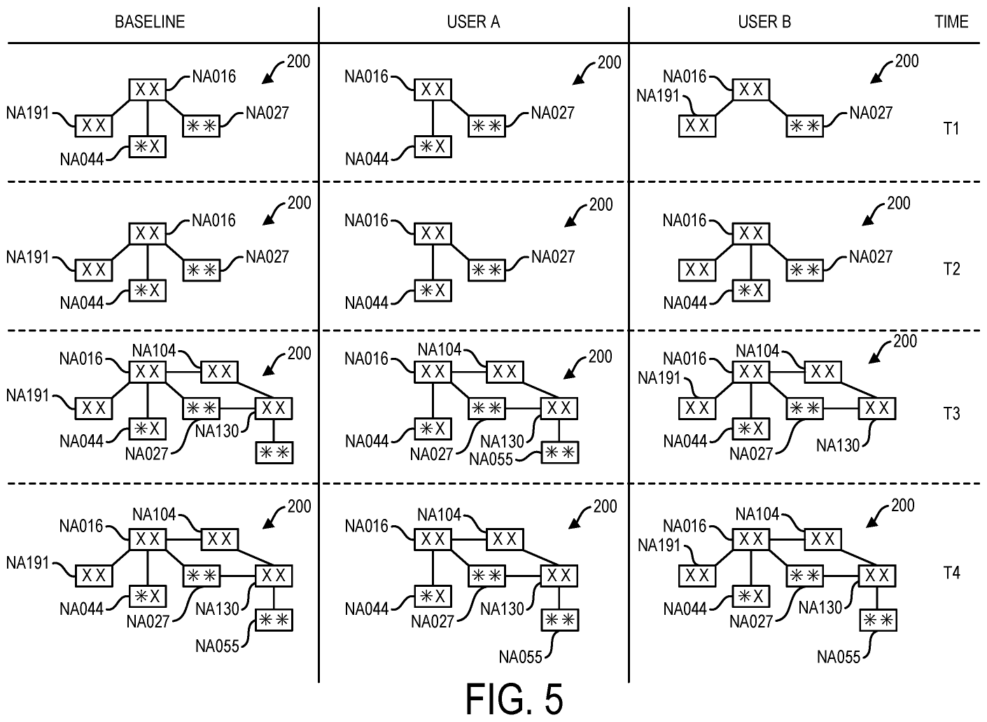

On completion of establishing block 1110, manager system 110 can proceed to adapting block 1111. At adapting block. 1111 manager system 110 can adapt the relationship graph 200 established at block 1110 differently for one or more user. Manager system 110 performing adapting of a baseline relationship graph 200 for different users is described in connection with FIG. 5. Manager system 110 can adapt a baseline relationship graph 200 differently for different users, e.g., based on demographic data of a user, e.g., based on knowledge level of the user for a current topic, which can be determined based on determined linguistic complexity of a user. Manager system 110 can adapt a baseline relationship graph 200 differently for different users, e.g., based on predicted engagement of a user with a data asset present in a baseline relationship graph 200. In any of the above scenarios, manager system 110 can adapt a relationship graph 200 differently for different users in dependence on historical data for the different users.

In FIG. 5, there is shown a progression of a baseline relationship graph 200 for presentment to users of a conversation over time wherein the relationship graph 200 can iteratively change over time. Referring to FIG. 5, there is shown a baseline relationship graph 200 (left-hand side) which manager system 110 can adapt differently for presentment on a user interface, e.g., display device of UE devices 120A-120B associated to user A and user B respectively. Relationship graph 200 can be presented on the display of UE device 120A of user A and can be adapted differently for personalized presentment on a display of UE device 120B associated to user B. Referring again to the flowchart of FIG. 2, manager system 110 at block 1111 can perform adapting of a baseline relationship graph 200 established at block 1110 and on completion of adapting block 1111 can proceed to block 1112. At block 1112, manager system 110 can perform presenting of different adaptations of relationship graph 200 to user A at UE device 120A and to user B at UE device 120B. At presenting block 1112, manager system 110 can send prompting data defined by relationship graph 200 in adapted form to UE device 120A for user A and to UE device 120B for user B. In response to the receipt of prompting data defined by relationship graph 200 in adapted form, UE device 120A at present block 1203 can present the prompting data defined by relationship graph 200 on UE device 120A at present block 1203 and on UE device 120B at present block 1213.

In response to observing the presented prompting data, user A can define and send feedback data at send block 1204 for receipt by manager system 110 and user B, in response to observing presented prompting data presented at block 1213 can define and send feedback data for receipt by manager system 110 at send block 1214. Feedback data can take the form e.g., of actuating presented asset of relationship graph 200 as set forth herein and/or can include presentment of conversation content of a current conversation, e.g., text based content or voice-based content. In the case of voice based content, the voice based content can be converted into text by running of speech to text process 117. In all text of all conversations in prompting data sessions, system 100 can be subject to extraction of natural language processing parameter values by running of NLP process 115. In response to the receipt of the described feedback data, manager system 110 at store block 1113 can store the described feedback data and can also store relationship graph 200s including the established relationship graph 200 established at the prior iteration of block 1110 in the adapted and presented relationship blocks adapted at block 1111 and presented at block 1112. At block 1114, manager system 110 can determine whether a current prompting data session has ended. A prompting data session can determine to have ended, e.g., when the current messaging system supported conversation is ended, when there is a time lag beyond a threshold time from a most recent message initiated by user of a user participant of a conversation, and/or when another session ending criterion has been satisfied. For a time that a current prompting data session remains active, manager system 110 can iteratively perform the loop of blocks 1109-1114. In one aspect, manager system 110 can adapt a presented relationship graph 200 differently for different users. In another aspect, presented relationship graph 200s presented to different users can dynamically change over time in real-time, e.g., in dependence on real-time user feedback data during the course of a prompting data session.

Aspects of presented adapted relationship graph 200s presented to different users are set forth in reference to FIG. 5. On the left-hand side of FIG. 5, a baseline relationship graph 200 is shown. Relationship graph 200 can include node NA016, node NA191, node NA027, and node NA044. Node NA016 can be a topic definitional node (anchor node) for presenting asset data of a topic definitional asset and nodes NA191, NA027, and NA044 can be nodes for presentment of asset data of assets determined to be related to the described topic definitional asset, e.g., by use of clustering analysis as described in connection with FIG. 5. The relationship graph 200 provided as a baseline relationship graph 200 in FIG. 5 can include nodes that present text without graphics data assets (indicated with double XXs), graphic without text data assets (indicated with double asterisks **) and/or graphics with text data assets (indicated with an asterisk combined with an X). Referring to FIG. 5, relationship graph 200 can present information on one or more topic, e.g., one or more topic referenced in a current conversation.

As set forth in reference to FIG. 5, relationship graph 200 can be adapted differently for presentment to user A and user B. User A can be associated to UE device 120A and user B can be associated to the UE device 120B. Referring to FIG. 5, user A column, node NA191 at time period T1 can be absent of a node. Referring to time T1, adapted relationship graph 200 for presentment to user A as shown in the middle column of FIG. 5, can be absent of node NA191 and relationship graph 200 for presentment to user B as shown in FIG. 5 at time T1 can be absent of node NA044.

In one use case, manager system 110 can adapt relationship graph 200 differently for presentment to user A and user B in dependence on determined linguistic complexity capability of user A and user B respectively and linguistic complexity level of asset data of node NA191 and NA044, respectively. The linguistic complexity level can define demographic data and knowledge level. In one use case, asset data of node NA191 and node NA044 can be pre-tagged with numerical amplitude value NLP data tags indicating the linguistic complexity levels of the asset data of NA191 and the asset data of node NA044, respectively. Further, manager system 110 can determine the predicted linguistic complexity capability of the user for the current topic (the topic of the anchor node) by query of linguistic complexity predictive model 4101 as set forth in reference to FIG. 3A.

In the use case described with reference to FIG. 5, manager system 110 can ascertain that user A has a higher than baseline linguistic complexity capability for the current topic referenced in the anchor node and user B has a lower than baseline linguistic complexity capability. For the current topic, manager system 110 can further ascertain that asset data of node NA191 has lower than baseline linguistic complexity and that asset data of node NA044 has higher than baseline linguistic complexity. Accordingly, because the asset data of node NA191 can be determined to be mismatched with the linguistic complexity capability of user A, manager system 110 can return an action decision to drop node NA191 from the adapted relationship graph 200 adapted for presentment to user A at time T1. Furthermore, because the asset data of node NA044 can be determined to be mismatched to the linguistic complexity capability of user B for the current topic, manager system 110 can return an action decision to drop node NA044 from the adapted relationship graph 200 adapted for presentment to user B at time T1. Thus, as explained with reference to time T1, manager system 110 can adapt the presented relationship graph 200 adapted for presentment to user A and user B in dependence to determine linguistic complexity capability of the respective users for the current topic and the linguistic complexity level of asset data associated for node of the baseline relationship graph 200.

Embodiments herein recognize that users can remain more engaged with the relationship graph 200 where content of the relationship graph 200 is matched to the user's linguistic complexity capability for a given topic. Referring to time T2 of FIG. 5, however, it is seen that the adapted relationship graph 200 adapted for presentment to user B at time T2 has grown and now includes the previously removed node NA044 having asset data with associated higher than baseline linguistic complexity level. Manager system 110 examining various real-time data from the current prompting data session can result in the change depicted by the dynamically varied relationship graph 200 for presentment to user B at time T2.

In one example, manager system 110 can examine feedback data received by manager system 110 sent at blocks 1204 and 1214 received subsequent to an initial presenting of adapted relationship graph 200s at presenting block 1112 of a current prompting data session. In one use case example, manager system 110 performing the second iteration of adapting block 1111 of a current prompting data session can include manager system 110 examining feedback data sent in a prior iteration of send block 1214. In one use case, feedback data received by manager system 110 responsively to send block 1214 can include feedback data that is input into linguistic complexity predictive model 4101 as shown in FIG. 3A defining a next iteration of training data for training linguistic complexity predictive model for user B.

The feedback data received by manager system 110 for use in training linguistic complexity predictive model 4101 can include message data having, in one use case, a significantly higher linguistic complexity level for a current topic than was previously expressed by user B. When the new feedback data is used to re-train linguistic complexity predictive model 4101, linguistic complexity predictive model 4101 can be retrained and now, on presentment of query data thereto, produces a prediction as to the linguistic complexity capability of user B such that user B is now predicted by query of linguistic complexity predictive model 4101 to have a higher than baseline linguistic complexity capability for a current topic, thus qualifying user B for being presented node NA044 for presentment of asset data having a higher than baseline complexity level.

For the use case described, node NA016 can conceivably be dropped from the adapted relationship graph 200 for presentment to user B at time T2 but various rules might apply to preserve the presentment of node NA044 to user B at time T2. For example, a rule may be applied such that a mismatched node is preserved for a user for a time period after a linguistic complexity capability for a user transitions.

According to another example that is depicted in FIG. 5, characteristics of baseline relationship graph 200 can dynamically change over time. In one use case example, manager system 110 can monitor a current conversation for identification of new topics. Time period T3 depicts the use case where manager system 110 detects in a current conversation the presence of a second topic that satisfies one or more criterion, e.g., satisfies a threshold topic strength condition and/or is a topic of interest to all users of a conversation, etc. The detection of a second topic manager system 110 can generate baseline relationship graph 200 (far left column) at time T3 such that the newly generated baseline relationship graph 200 has new nodes NA104, NA130, and NA055.

In the described example, node NA104 can be a topic definition node that presents asset data for topic definitional asset and nodes NA130 and node NA055 can be nodes determined using the described clustering analysis of FIG. 4 to be nodes having asset data determined by the clustering analysis as set forth in FIG. 4 to be related to the topic associated to node NA104. Further, referring to time T3, manager system 110 adapts relationship graph 200 for presentment to user B so that node NA055 is removed from the relationship graph 200 presented to user B.

Referring to time T3, manager system 110 in adapting relationship graph 200 for presentment to user B can predict that user B will have a low (e.g., below threshold numerical value) level of engagement with the presented graphics associated to node NA055. For predicting the level of engagement with the node NA055, manager system 110 can query node engagement predictive model 5101 as shown in FIG. 3B for determining the predicted level engagement with a particular type of node of a relationship graph 200.

Node engagement predictive model 5101 can be trained with iterations of training data and once trained, node engagement predictive model 5101 can be configured to predict an engagement of a user with a particular node of a relationship graph 200. Node engagement predictive model 5101 can be trained with iterations of training data. Each iteration of training data can include a dataset which comprises (a) topic, (b) node type, and (c) level of engagement. Referring to FIG. 3B depicting training of node engagement predictive model 5101, node type can specify e.g., the types (i) text without graphics, (ii) graphics without text, or (iii) text with graphics. Engagement level can specify the level of engagement of the user with a node in a historical prompting data session. Engagement level can include, e.g., (a) no engagement, (b) actuating an active node, e.g., having a hyperlink, or (c) presenting conversation content referencing asset data of a node as set forth herein. Node engagement predictive model 5101, once trained, can be configured to predict a level of engagement of a user with any presented node of a relationship graph 200.

Referring again to FIG. 5, manager system 110 at time T3 on query of node engagement predictive model 5101 of FIG. 3B can ascertain that user B will have no engagement with node NA055 and, hence, can drop NA055 from relationship graph 200 adapted for presentment to user B at time T3. For example, at time T3, training data for training node engagement predictive model 5101 may have consisted of training data that specified that the user has never, or only very rarely, engaged graphics-containing nodes for presenting topic data associated to the topic of node NA104. However, as shown by FIG. 5, manager system 110 at time T4 corresponding to a next iteration of adapting block 1111 can ascertain by re-query of node engagement predictive model 5101 that the predicted engagement of user B to node NA055 will exceed a threshold level and therefore can decide at time T4 to include node NA055 in adapted presented relationship graph 200 presented to user B at time T4. In one example, between time T3 and T4, node engagement predictive model 5101 can be re-trained with the next iteration of training data that retrains node engagement predictive model 5101 to return a changed result as to the predicted engagement of user B to node NA055. In one example, feedback data sent at block 1214 received by manager system 110 subsequent to time T3 and prior to T4 can be used to re-train node engagement predictive model 5101. Such feedback data can include session data specifying that user B after time T3 and prior to T4 has actuated or otherwise positively engaged graphics without text node NA027 of relationship graph 200. Referring to node engagement predictive model 5101, a most recent iteration of training data can re-train node=engagement predictive model 5101 so that when manager system 110 re-queries node engagement predictive model 5101, node engagement predictive model 5101 returns a result that user B will have a higher than baseline level of engagement with node NA055 and therefore, at time T4, based on user B's recent engagement with node NA027 will include graphic space node NA055 in the adapted and presented relationship graph 200 presented to user B at time T4.

In one embodiment, manager system 110 for performing adapting at block 1111 can evaluate each node of a baseline relationship graph 200 for inclusion in an adapted relationship graph 200 presented to a user use of Eq. 2 below.

Manager system 110 can employ the formula of Eq. 1 for assigning adaptation scores to a current asset being evaluated for inclusion in an adapted relationship graph 200 for presentment to a user.

$$A = AF 1 W 1 + AF 2 W 2 + AF 3 W 3 \qquad ( Eq . 2 )$$

Where A is the adaptation score for an asset being evaluated, AF1 is a first adaptation factor, AF2 is a second adaptation factor, AF3 is a third adaptation factor and W1-W3 are weights associated to the various factors. In one embodiment, AF1 can be a knowledge matching factor. Manager system 110 can be configured to include a node of a baseline relationship graph where the adaptation score A satisfies a threshold and can exclude a node from an adapted relationship graph where the adaptation score does not satisfy a threshold.

Embodiments herein recognize that a level of engagement of a user to a relationship graph 200 can be improved if presented asset data content is matched to a knowledge level of the user. Knowledge matching, in one example, can be performed with use of the linguistic complexity matching as set forth herein. As set forth herein, a linguistic complexity capability of a user on a per topic basis can be determined and presented asset data can be retained or dropped depending on the degree of matching of a linguistic complexity of an asset relative to a linguistic complexity capability of a user. Manager system 110, in evaluating a node of a baseline relationship graph for inclusion in an adapted relationship graph for presentment to a user, can scale scores assigned under factor AF1 in dependence on a degree of matching between a linguistic complexity knowledge level of a user and a linguistic complexity level of an asset associated to the node.

In one embodiment, factor AF2 can be an asset data type factor. As explained with reference to node engagement predictive model 5101 of FIG. 5, users can be predicted to have different levels of engagement depending on asset data type (text, graphics, graphics and text). Manager system 110 can scale assigned scoring values under factor F2 according to a predicted engagement level of a user based on data type of asset data being evaluated.

Factor AF3 can be a staleness factor. Embodiments herein can iteratively adapt a presented relationship graph for presentment to a user for improved engagement with a user and for maintaining engagement of a user. In one aspect, manager system 110 can change a currently adapted relationship graph presented to the user on the determination that a user is not substantially using a currently adapted and presented relationship graph. Such functionality is described in reference to factor AF3.

As is expressed in factor AF3, embodiments herein can change the relationship graph in response to a determination that a user is not substantially using a relationship graph. Manager system 110 can scale scoring values under factor AF3 according to a staleness of a currently presented relationship graph presented to a user. Staleness of a currently presented relationship graph can be ascertained by evaluating engagement of each node of a relationship graph under factors F1-F5 of Eq. 1, and can aggregate (e.g., average) scores of nodes to ascertain an overall staleness score for an adapted relationship graph. Staleness scores for each node can be applied as scores inversely proportional to engagement scores applied under factors F1-F5. Where a node under evaluation is not currently presented, manager system 110 can scale assigned scoring values under factor AF3 accordingly to determined staleness scores for an adapted relationship graph 200. Thus, where an adapted relationship graph has become stale and is not being substantially used, manager system 110 with operation of factor AF3 is more likely to qualify evaluated change for implementing an adapted relationship graph, and more likely to change an attribute of a presented relationship graph. Factor AF3 promotes changing of an adapted relationship graph where a user is not substantially using a presented relationship graph. In one embodiment, the weight W3 can be provisioned so that responsively to a level of engagement of a user with a presented relationship graph falling below a threshold engagement level, manager system 110 changes the presented relationship graph 200.

In one use case which can be envisioned in reference to FIG. 5, first and second users can be engaged in a conversation. Manager system 110 can be subjecting text of the conversation to natural language processing for topic extraction. Manager system 110 can activate a prompting data session in response to detecting a first topic. On detection of a topic, manager system 110 can initiate a prompting data session characterized by a relationship graph 200 being presented to first and second users. Manager system 110 can dynamically update a relationship graph during the session. For example, manager system 110 can detect a new topic and can add a node to the relationship graph for the new topic. In another example, manager system 110 can add asset data of a user participant of the conversation during a prompting data session. Manager system 110 can adapt the graph differently for first and second users. Manager system 110 can subject data assets to natural language processing for extraction of linguistic complexity. Manager system 110 can predict a linguistic complexity of a user for a certain topic with use of historical data assets of the user. In one aspect, manager system during a prompting data session can adapt a presented relationship graph so that a presented relationship graph 200 has a linguistic complexity that matches a linguistic complexity of a user. In one aspect, a relationship graph can present asset data on numerous topics and users can have different user linguistic complexity capability in the different topics, e.g., higher than baseline linguistic complexity capability for a first topic, lower than baseline linguistic complexity capability for a second topic, where baseline is determining by aggregating, e.g., averaging data of all users. Thus, for a portion of a relationship graph, manager system 110 can match a relationship graph to a user's linguistic complexity capability by retaining asset data having higher than baseline linguistic complexity, and for a portion of a relationship graph, manager system 110 can match a relationship graph to a user's linguistic complexity capability by retaining asset data having lower than baseline linguistic complexity.

In one scenario, first and second users can be discussing various topics and a first topic can be detected. Manager system 110 can determine that a first user has a higher than baseline (average) knowledge level (which can be measured by determining linguistic complexity capability) for the first topic and the second user can have a lower than baseline knowledge level (which can be measured by determining linguistic complexity capability) for the first topic. Manager system 110 can establish a baseline relationship graph for the first topic and can adapt the presented relationship graph differently for the first and second users, retaining nodes having higher than baseline linguistic complexity for the first topic for the first user, and retaining nodes having lower than baseline linguistic complexity for the first topic for the second user. Manager system 110 can present the different versions of the relationship graph 200 for several iterations. Then, manager system 110 by subjecting conversation data to natural language processing can detect a second topic, and manager system 110 can expand the baseline relationship graph 200 to include a topic definitional relationship graph for the second topic. Manager system, e.g., using the linguistic complexity predictive model 4101, can determine that the first user has a lower than baseline knowledge level for the second topic and that the second user can have a higher than baseline knowledge level for the second topic. Manager system 110 can establish an expanded baseline relationship graph having topic definitional nodes N for the first topic and the second topic and can adapt the presented relationship graph differently for the first and second users, retaining nodes having higher than baseline linguistic complexity for the first topic for the first user, retaining nodes having lower than baseline linguistic complexity for the first topic for the second user, retaining nodes having lower than baseline linguistic complexity for the second topic for the first user, and retaining nodes having higher than baseline linguistic complexity for the second topic for the second user. Embodiments herein recognize that conversations can involve users having expertise in different topics. For example, a first user can have expertise in cloud computing technologies and minimal knowledge in financial accounting and a second user can have minimal knowledge in cloud computing and expertise in financial accounting. During the conversation of the current prompting data session, feedback data of first and/or second users can be subject to examining and presented relationship graphs 200 can be adapted in dependence on the examining during the current prompting data session. In one example, manager system 110 can change a presented relationship graph presented to a user responsively to detection that an engagement level of a user has fallen below a threshold level (factor AF3 of Eq. 2). In another example, processing of real-time feedback data can include re-training of linguistic complexity predictive model 4101 to result in the first user having a predicted higher than baseline expertise on the second topic (e.g., financial accounting). For example, historical pre-session data used to train linguistic complexity predictive model 4101 can result in linguistic complexity predictive model 4101 predicting that the first user has lower than baseline knowledge level on the second topic, but processed session data (e.g., spoken words of the first user, converted to text and subject to natural language processing for extraction of linguistic complexity parameter values) can be used to retrain linguistic complexity predictive model 4101 to produce updated predictions as to the first user's knowledge level on the second topic. The updated predictions by operation of an iteration of adapting block 1111 (FIG. 2) can result in adding nodes of a baseline relationship graph of the second topic having higher than baseline linguistic complexity on the second topic and dropping nodes of a baseline relationship graph of the second topic having lower than baseline linguistic complexity on the second topic. Embodiments herein can feature adapting a relationship graph 200 for presentment to different users including by translating text to a different language in dependence on languages spoken by users. In one example, seq2seq modelling can be used for language translation. A seq2seq model, in one example, can include an encoder and a decoder. The encoder and decoder can be provided by recurrent neural network (RNN) models according to one example.

Various available tools, libraries, and/or services can be utilized for implementation of predictive model 4101 and/or predictive model 5101. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring, and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring, and retraining deployed models. Predictive model 4101 and/or predictive model 5101 can employ use of, e.g., support vector machines (SVM), Bayesian networks, neural networks, and/or other machine learning technologies.

Embodiments herein recognize that a pandemic may present challenges that may lead to significant changes in operating models of almost every business. Remote working has become the norm and will stay that way in the foreseeable future. Remote working collaboration tools have proliferated. Yet, examples herein recognize that virtual collaboration has its challenges, especially where workers are not well versed in use of collaboration aids. Challenges include but are not limited to proficiency in screening sharing, firewall permission issues, application installation and updates, and knowledge of data regulations in terms of what can be shared on screen. These factors hamper collaboration and decrease productivity in meetings and collaboration sessions. Embodiments herein recognize that further challenges persist where collaborating workers are located in different areas and/or have different backgrounds including educational and knowledge backgrounds. Embodiments herein recognize that workers from different parts of the world and of different backgrounds and/or professions may have different ways of thinking and different ways of visualizing and perceiving ideas, thoughts, and concepts.

Embodiments herein can address various challenges including remote collaboration challenges with an intelligent digital visual aid that can automatically map the various thoughts and topics discussed in meetings, collaboration, and brainstorming sessions in real-time and thereby letting participants focus on core discussion. The intelligent digital visual aid can use cognitive technologies to produce highly contextualized and personalized relationship graphs 200 (mind maps) in real-time, combining various inputs such as demographics, profession, age range, geolocation, facial expressions, eyeball movement, acoustics inputs, literature shared in meetings, and the like. The applicability of the described aids can be expanded to various other fields such as aiding retention for challenged students, breaking down complex topics into simple subtopics, democratizing legacy knowledge, and the like.

There is set forth herein, in one embodiment, a method and framework to generate a relationship graph 200 (mind map) using a multi-stage process based on real-time factors and machine learning that allows consideration of individual's ability and requirement to fine tune and adapt a presented relationship graph 200. Embodiments herein can create a baseline relationship graph 200 (mind map) at a first stage and then can further refine the relationship graph 200 at a message delivery point based on individual's requirement to make to more personalized. It also considers personalizing the mind map based on a machine learning process that can be based on various factors, e.g., demographics including knowledge level, geo-location, and other factors.

Embodiments herein can create a linkage of a topic being discussed in the past for the same user while personalizing presentation of a presented relationship graph 200.

Embodiments herein can create a relationship graph 200 (mind map) of literature for faster and easy understanding of various topics with its visual representation covering linkages (being referred to as tresses for an individual session) and details hidden in various sections, pages or chapters of literature. There can be provided identification of topic and domain at a message origination level when a topic is being presented by a host.

There can be provided extracting main topics from a knowledge store using a similarity index for topic dimensionality. The extracting can feature use of natural language processing.

There can be provided establishing a base mind map based on existing toolset and further fine tuning the mind map for one or more user based on the individual's content, topic reading, watching activity, their expression level, machine learning on audience segmentation, and/or their historical topic understanding level.

Embodiments herein can feature adapting a relationship graph 200 for presentment to different users including by translating text to a different language in dependence on languages spoken by users. In one example, seq2seq modelling can be used for language translation. A seq2seq model, in one example, can include an encoder and a decoder. The encoder and decoder can be provided by recurrent neural network (RNN) models according to one example.

One to one language translation of text in a relationship graph 200 can be performed and passed as a parameter in refined adapted relationship graph 200 (mind map) adapted for personalized presentation to a user. There can be provided, e.g., capability to link various parts of literature (as delineated in a knowledge store), ability to link sections when there is a conceptual connection, ability to zoom in for details of a specific subject from an overall topic, ability to compare entities or process, and ability to show sequential views.

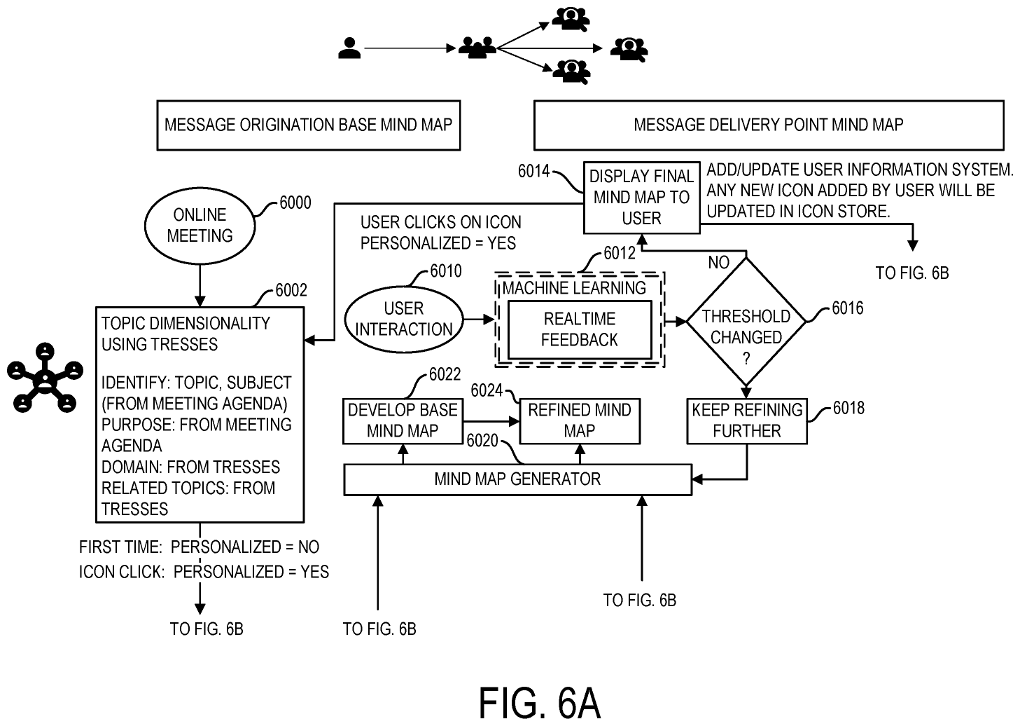

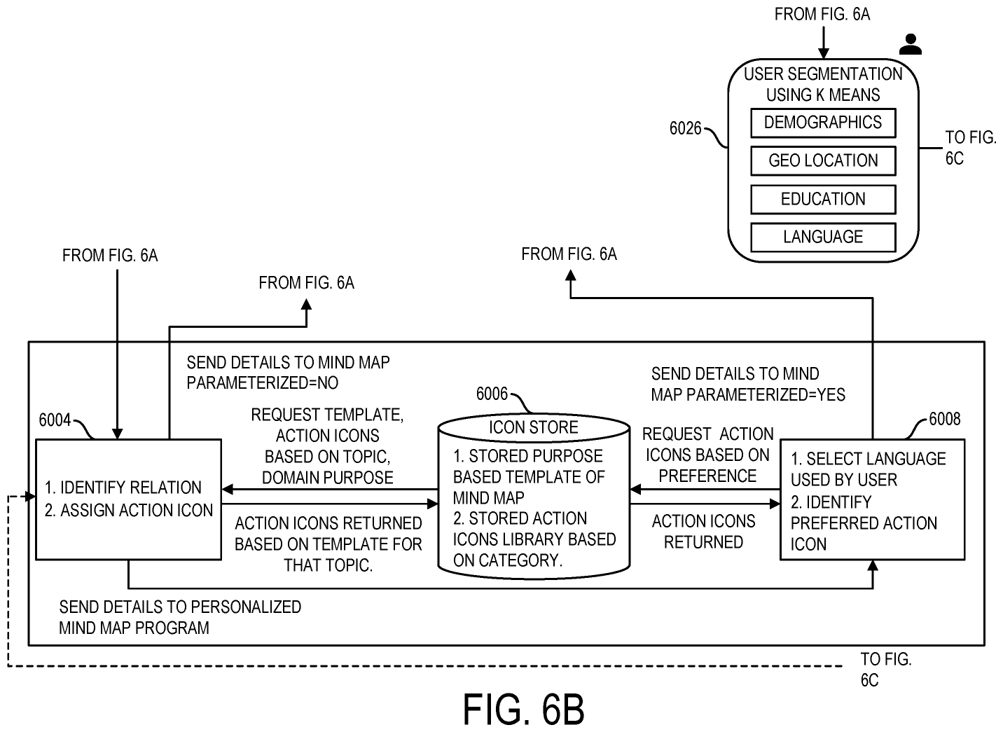

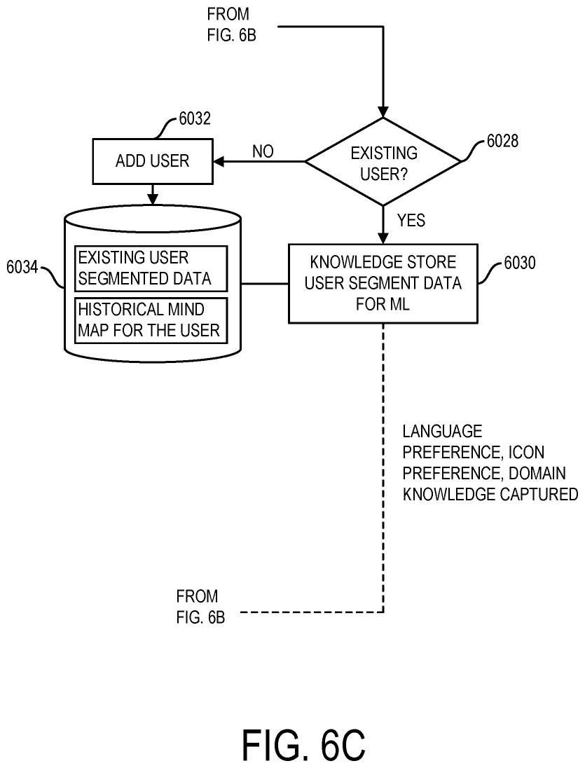

Further aspects are set forth in reference to blocks 6000-6034 in the flow diagram of FIG. 6A-6C. In one example, there can be performed (A) identification of topic and domain at a message origination level when a topic is being presented by a host. In one example, there can be performed using natural language processing for extracting the main topics from dataset using tresses for topic dimensionality. In one example, conversation content can be subject to natural language processing for extraction of a topic. Conversation content can include, e.g., words of users, e.g., in original text or text converted from voice. In another example, conversation content can include, e.g., posted content of a user during a conversation, e.g., hosted on a video conferencing platform. The posted content can include, e.g., a shared presentation or other document. In one example, original text defining conversation content can include: [Para 1: The process of making of food by green plants in the presence of sunlight and chlorophyll is known as photosynthesis. Green plants make their food themselves. They make food from Carbon dioxide and water in the presence of sunlight and chlorophyll.] Tokenized and lemmatized document: [‘process’, ‘food’, green’, ‘plant’, ‘sunlight’, ‘chlorophyll’, ‘photosynthesis’, ‘Carbon dioxide’, ‘water’] Topic: Life Science→Words: “photosynthesis”, “food”, “green”, “plant”, “chlorophyll”.

In reference to the flow diagram of FIG. 6A-6C, there can be performed (B) establishing a baseline relationship graph 200 (mind map) based on (A) above. A relationship graph 200 can have nodes connected by edges as set forth herein.

There can be performed (C) further fine tuning of the relationship graph 200 (mind map) for user's interaction. For (C), there can be performed machine learning on audience segmentation and their historical topic understanding level.

In one embodiment, segmentation can be performed via unsupervised learning, e.g., K means clustering. Information can be fetched from data repository 108 in real-time based on historical information and any new user preference information can be stored in real-time. Where language translation is performed based on demographic data of a user, seq2seq modelling can be used. A seq2seq model, in one example, can include an encoder and a decoder. The encoder and decoder can be provided by recurrent neural network (RNN) models according to one example.

There can also be performed (D) refining and an individual's presented relationship graph 200 based on continuous expression level and an individual's real-time harmonic [normalized] evaluation input until an individual's understanding crosses a defined threshold value. Real-time harmonic [normalized] evaluation recognition can be performed using deep learning (e.g., with use of python and/or OpenCV). In one example, the input can be taken as an input parameter from a user (Yes/No). In one use case, a user can be prompted for questions for further refinement. Various prompting text data can be presented to a user: Is it too simple? Is it too complicated? Do you want to see in different language? Do you want to see previous session relationship graph 200?

In one example there can be performed with reference to blocks 6000-6034 of the flow diagram of FIG. 6A-6C the following: (1) Pre-process the raw text using NLTK and gensim libraries; (2) Tokenization (split text into sentences/sentences into words); (3) Remove small/stop words; (4) Lemmatize the words (change third person to first person, past/future to present); (4) Reduce the words to root form (stemming); (5) Original document: [‘This’, ‘disk’, ‘has’, ‘failed’, ‘many’, ‘times.’, ‘T’, ‘would’, ‘like’, ‘to’, ‘get’, ‘it’, ‘replaced.’]; (6) Tokenized and lemmatized document: [‘disk’, ‘fail’, ‘time’, ‘like’, ‘replac’]: (7) Convert text into dictionary by identifying the word (key) and its number of occurrences (value) in entire corpus (use genism.corpora.dictionary); (8) Use [symbol] -similarity index for topic dimensionality: (a) Input: number of topics identified, number of passes, historic data, and the relevant tuples; (b) Tuple:[↑], as the time series values that are historically available for an individual; (c) Tuple: [ [symbol] ], as the time series values that are historically available for the reference trend: (d) α, Individual tresses across the trie-tree: (e) β, references tresses across the trie-tree; (9) Interpret the results: (a) Topic 1: Possibly Graphics Cards→Words: “drive”, “sale”, “driver”, *“wire”, “card”, “graphic”, “price”, “appl”, “softwar”, “monitor”: (b) Topic 2: Possibly Space→Words: “space”, “nasa”, “drive”, “scsi”, “orbit”, “launch”, “data”, “control”, “earth”, “moon”: (c) Topic 3: Possibly Sports→Words: “game”, “team”, “play”, “player”, “hockey”, season”, “pitt”, “score”, “leagu”, “pittsburgh”: (d) Topic 4: Possibly Politics→Words: “armenian”, “public”, “govern”, “turkish”, “columbia”, “nation”, “presid”, “turk”, “american”, “group”; (9) real-time harmonic [normalized] evaluation, wherein real-time harmonic [normalized] evaluation (a) can be performed using Deep Learning (python and OpenCV); (b) can include finding contour, the maximum contour that can be used to establish a pattern; (c) can include making a convex hull around the area; (d) finding % area not covered by area, wherein every realtime harmonic [normalized] evaluation has a unique area % ratio, which will differentiate between them.

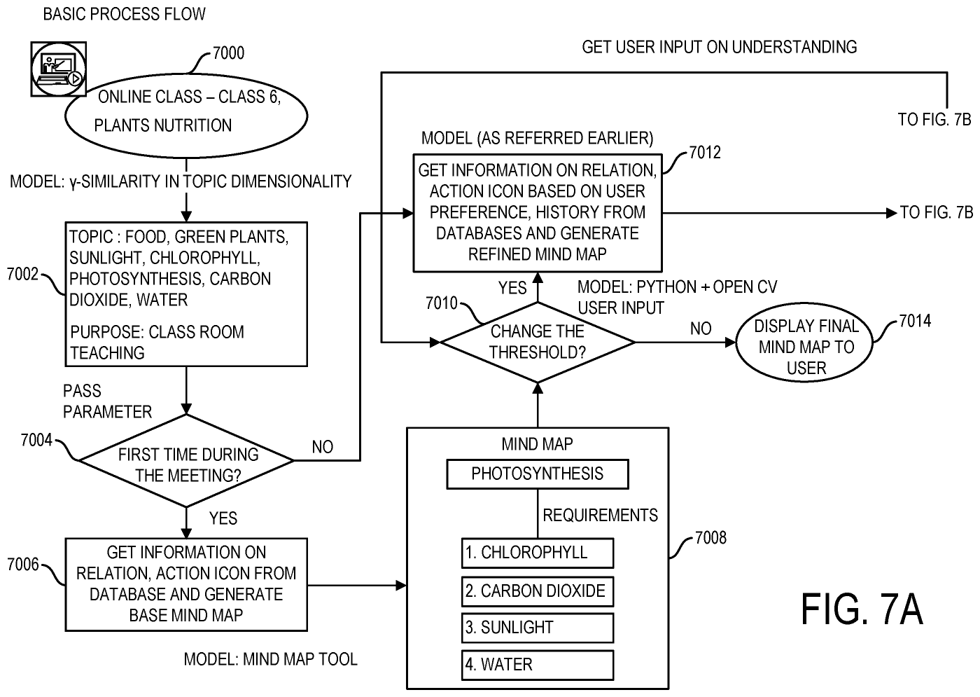

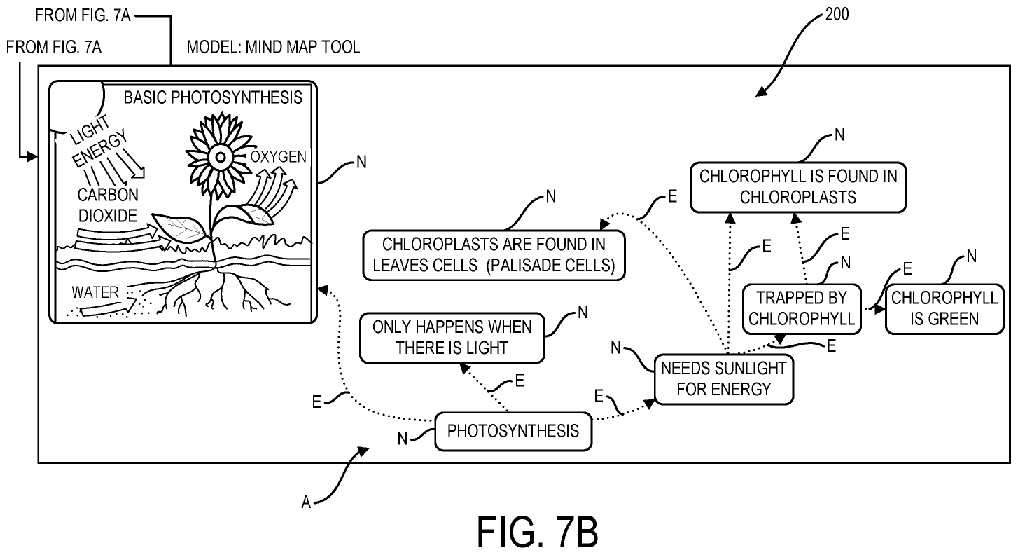

In reference to FIGS. 7A and 7B there is illustrated in reference to blocks 7000-7014 (FIG. 7A) an example of providing a relationship graph 200 (FIG. 7B) having nodes N (including topic definitional node N at “A”) and edges E.

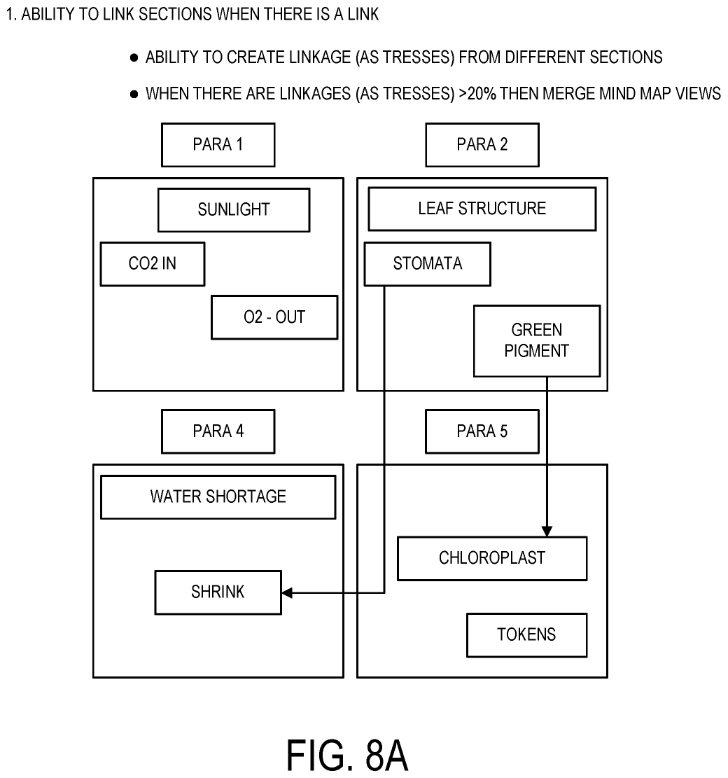

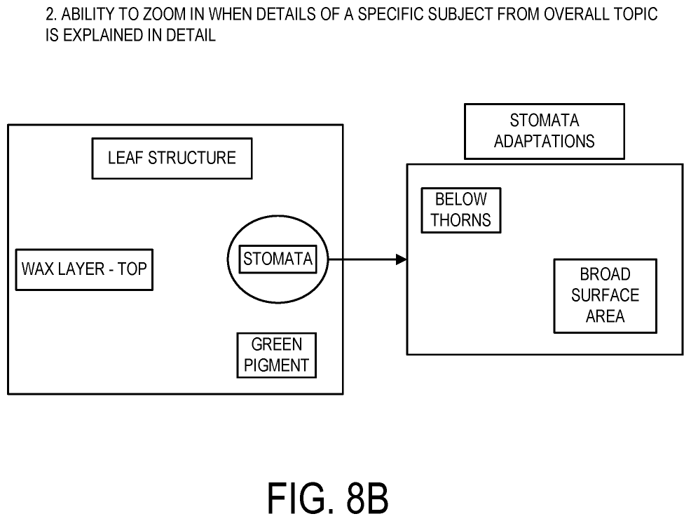

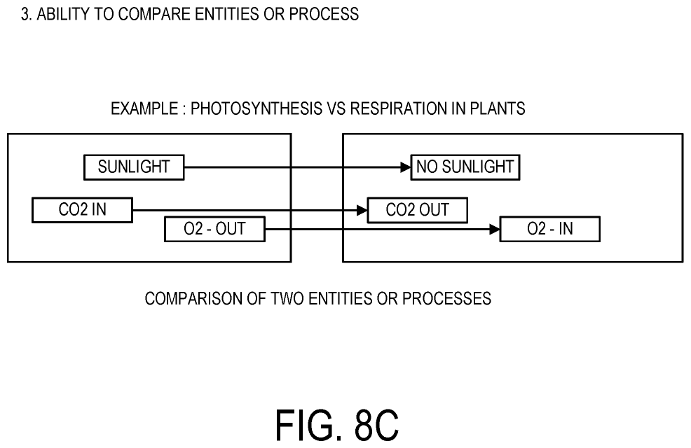

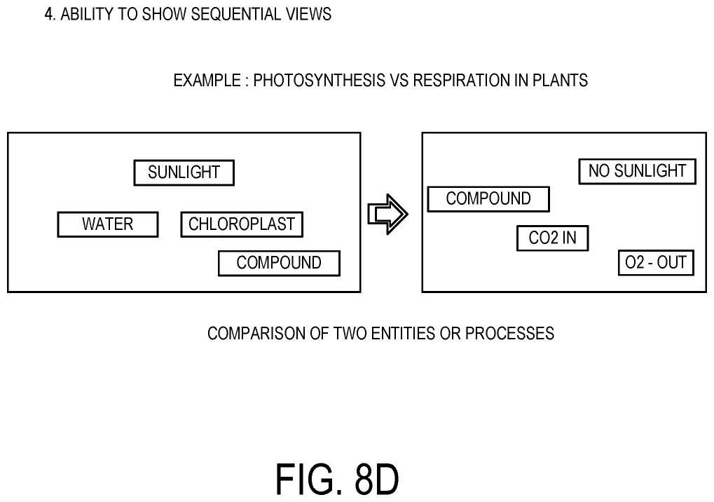

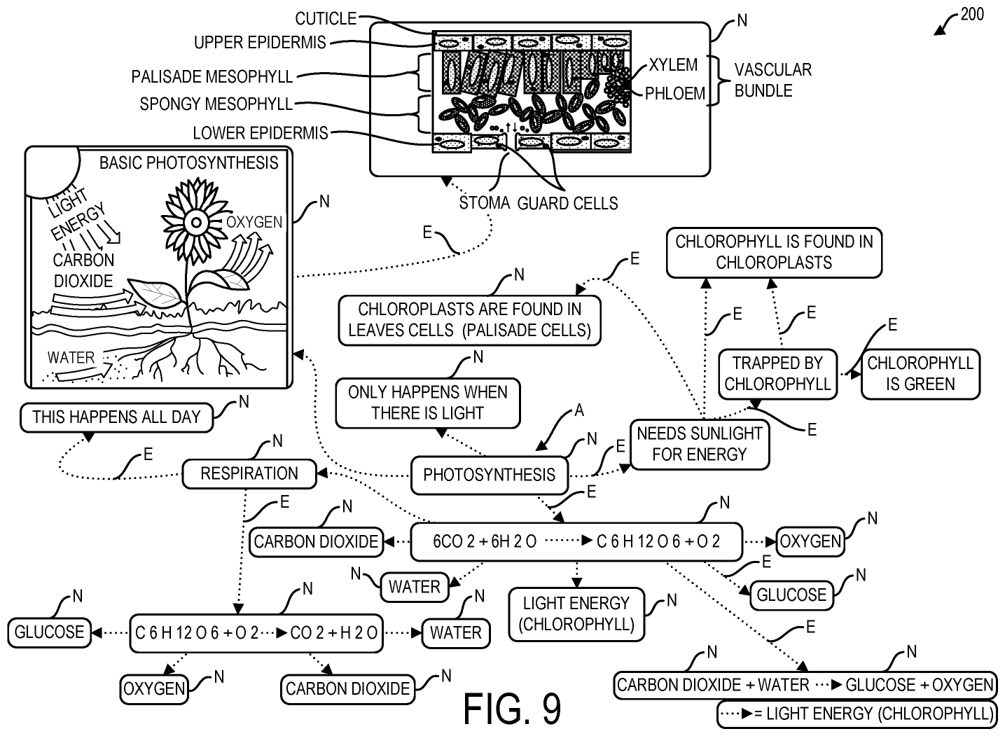

Various additional features are illustrated in reference to FIGS. 8A-8D. In FIG. 8A there is illustrated an ability to link sections. In FIG. 8B, there is illustrated an ability to zoom in for additional details. In FIG. 8C, there is illustrated an ability to compare entities. In FIG. 8D, there is illustrated an ability to present sequential views.

In FIG. 9 there is illustrated a relationship graph 200 having nodes N and edges E. Relationship graph can include node N at “A” configured as a topic definitional node.

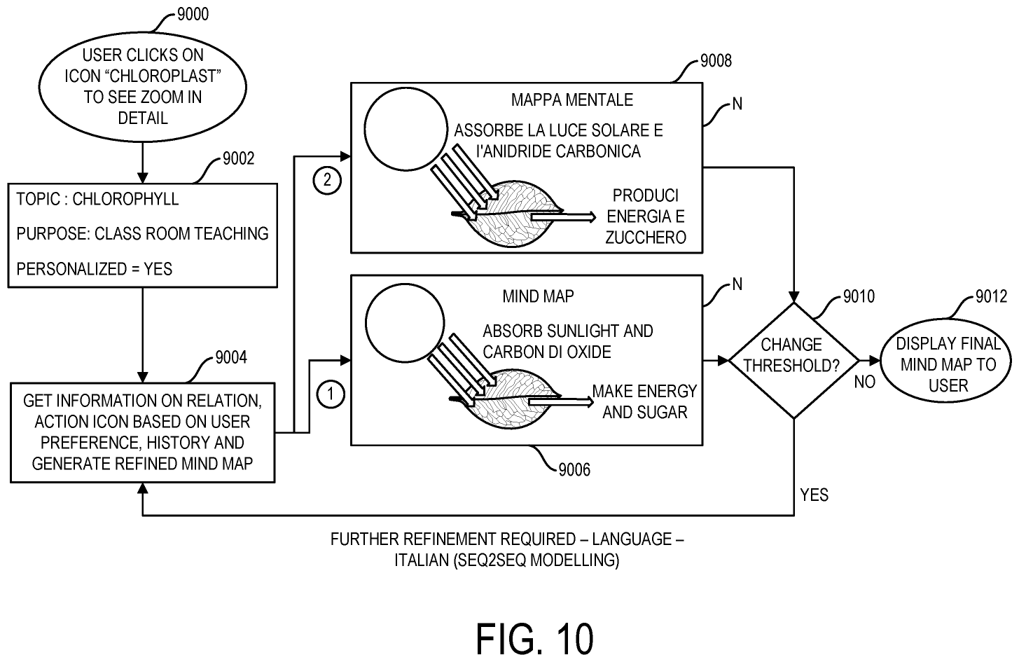

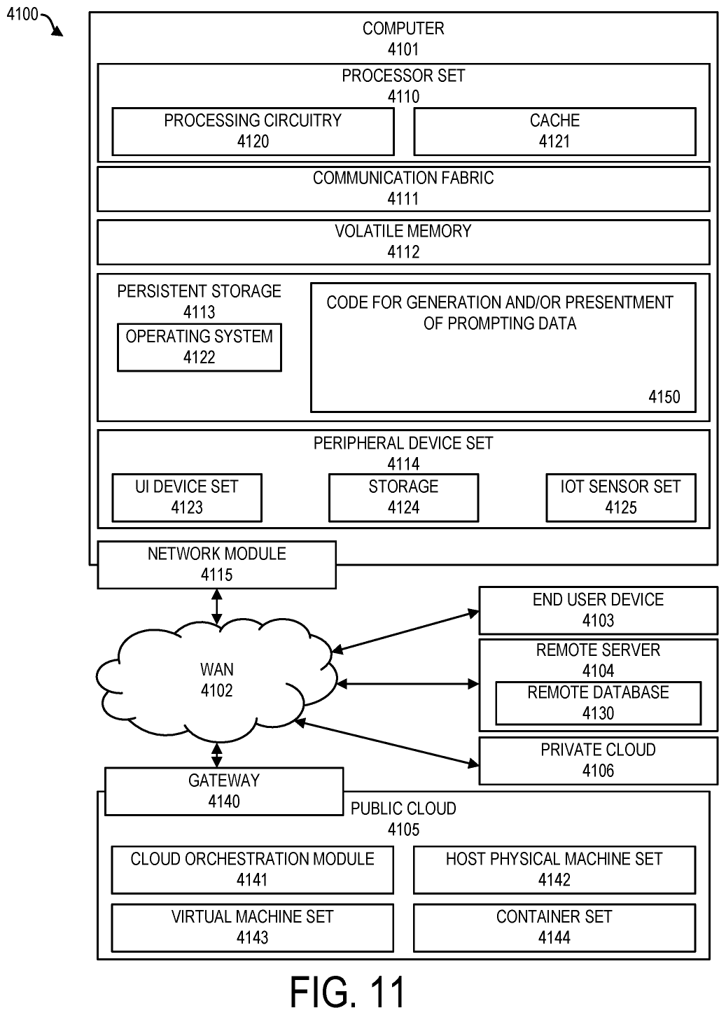

In FIG. 10 there is illustrated with reference to blocks 9000-9012 an example of adapting a relationship graph 200 for presentment to a user, wherein text of a node N is subject to language translation.

Certain embodiments herein may offer various technical computing advantages involving computing advantages to address problems arising the realm of computer systems. Embodiment herein can feature improved user interface technologies wherein prompting data can be iteratively presented to one or more user. In one aspect, the prompting data presented to the one or more user can dynamically change over time in dependence on various examined data including examined feedback data received from a user during a current prompting data session wherein the user is a user who is prompted with prompting data. Prompting data can take the form in one embodiment of a relationship graph which presents information on one or more topic. Nodes of a relationship graph can be provided by text based nodes that present text based asset data and graphics based nodes that present graphics based data. Embodiments herein can iteratively train one or more predictive model. Training data for training the one or more predictive model can include feedback data obtained during an interactive prompting data session in which one or more users presented with dynamically changing prompting data defined by one or more relationship graph. In one aspect, with use of feedback data and trained predictive models that can be trained with feedback data embodiments herein can feature the presentment of multiple differentiated relationship graph that are differentiated in their presentment between first and second users. In one aspect, a manager system can dynamically and iteratively adapt a presented personalized relationship graph differently to first and second different users of a current relationship graph. In another example, a presented relationship graph can be changed in response to monitoring indicating that a user's engagement has fallen below a threshold level, thus prompting user engagement with a relationship graph. The presented relationship graph can be dynamically changed over time in real-time in dependence on the examination of real-time data including real-time feedback data associated to a current prompting data session in which one or multiple users are presented dynamically changing prompting data that can be provided by dynamically changing relationship graphs. By iteratively updating presented prompting data in a manner that depends on real-time feedback data, most relevant prompting data can be selectively presented to one or more user to increase the likelihood that the one or more user engages the prompting data and performs the prompted for action prompted for by the prompting data. Prompted for action can include productively contributing to a current conversation performing research including online research, executing certain online tasks and producing one or more work product. The fundamental aspect of operation of a computer system is its interoperation with entities with which it operates, including human actors. By increasing the accuracy and reliability of information presented to human actors, embodiments herein can increase the level engagement of human users for enhanced computer system operation. Machine learning processes can be performed for increased accuracy and for reduction of reliance on rules based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing. Embodiments herein can examine data from diverse data sources such as data sources. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

In reference to FIG. 11 there is set forth a description of a computing environment 4100 that can include one or more computer 4101. In one example, a computing node as set forth herein can be provided in accordance with computer 4101 as set forth in FIG. 11.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 1. In one example, a computing environment 4100 contains an example of an environment for the execution of at least some of the computer code involved in performing the inventive methods, such as code 4150 for generation and/or presentment of prompting data, functionality of which is described with reference to methods of FIGS. 1-10 set forth herein. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
examining user data of at least one user to determine whether a criterion has been satisfied for running a prompting data session for prompting the at least one user;
responsively to determining that the criterion has been satisfied for running the prompting data session for prompting the at least one user, running a prompting data session, wherein the running the prompting data session includes (a) establishing and iteratively updating a relationship graph and (b) presenting the iteratively updated relationship graph to one or more user.

2. The computer implemented method of claim 1, wherein the examining user data of the at least one user includes monitoring a conversation involving first and second users.

3. The computer implemented method of claim 1, wherein the examining user data of the at least one user includes monitoring a conversation involving first and second users, wherein the monitoring includes subjecting content of the conversation to natural language processing for topic extraction.

4. The computer implemented method of claim 1, wherein the examining user data of the at least one user includes monitoring a conversation involving first and second users, wherein the monitoring includes converting voice based content of the conversation to text, and subjecting the text to natural language processing for topic extraction.

5. The computer implemented method of claim 1, wherein the examining user data of the at least one user includes monitoring a conversation involving first and second users, wherein the monitoring includes subjecting content of the conversation to natural language processing for topic extraction for extraction of a certain topic, wherein the establishing is performed so that the iteratively updated relationship graph presents information on the certain topic.

6. The computer implemented method of claim 1, wherein the examining user data of the at least one user includes monitoring a conversation involving first and second users, and wherein the presenting the iteratively updated relationship graph to one or more user includes adapting the iteratively updated relationship graph differently for the first and second users so that the iteratively updated relationship graph is presented differently to the first and second users.

7. The computer implemented method of claim 1, wherein the presenting the iteratively updated relationship graph to one or more user includes presenting an iterative adapted version of the iteratively updated relationship graph to a first user, wherein the method includes during the presenting (1) monitoring engagement of the first user with the relationship graph, and (2) changing the iterative adapted version to include an asset data presenting node in dependence on the monitoring engagement of the first user indicating that an engagement of the first user with the relationship graph has fallen below a threshold level of engagement.

8. The computer implemented method of claim 1, wherein the presenting the iteratively updated relationship graph to one or more user includes presenting an iterative adapted version of the iteratively updated relationship graph to a first user, wherein the method includes during the presenting the iteratively updated relationship graph (1) monitoring engagement of the first user with the relationship graph, and (2) changing the iterative adapted version to include an asset data presenting node in dependence on the monitoring engagement of the first user indicating that an engagement of the first user with the relationship graph has fallen below a threshold level of engagement, wherein the monitoring engagement of the first user includes monitoring one or more of the following selected from the group consisting of (i) whether asset data of the relationship graph configured as a hyperlink has been activated by the first user during a current prompting data session, (ii) a speed which the first user actuated asset data of the relationship graph during the current prompting data session, (iii), force with which the first user has actuated asset data of the relationship graph during the current prompting data session, (iv) whether the first user referenced content of asset data the relationship graph in spoken words of the first user during the current prompting data session, and (v) an eye gaze of the first user on asset data of the relationship graph during the current prompting data session.

9. The computer implemented method of claim 1, wherein the examining user data of the at least one user includes monitoring a conversation involving first and second users, and wherein the presenting the iteratively updated relationship graph to one or more user includes adapting the iteratively updated relationship graph differently for the first and second users so that the iteratively updated relationship graph is presented differently to the first and second users, wherein adapting the iteratively updated relationship graph differently for the first and second users includes querying a predictive model that has been trained with user data of at least one of the first or second user.

10. The computer implemented method of claim 1, wherein the examining user data of the at least one user includes monitoring a conversation involving first and second users, and wherein the presenting the iteratively updated relationship graph to one or more user includes adapting the iteratively updated relationship graph differently for the first and second users so that the iteratively updated relationship graph is presented differently to the first and second users, wherein the adapting the iteratively updated relationship graph differently for the first and second users so that the iteratively updated relationship graph is presented differently to the first and second users includes predicting a linguistic complexity capability of the first user, predicting a linguistic complexity capability of the second user, removing a first node of the relationship graph for presenting the relationship graph to the first user in dependence on the predicted linguistic complexity capability of the first user, removing a second node of the relationship graph for presenting the relationship graph to the second user in dependence on the determined linguistic complexity capability of the second user.

11. The computer implemented method of claim 1, wherein the examining user data of the at least one user includes monitoring a conversation involving first and second users, and wherein the presenting the iteratively updated relationship graph to one or more user includes adapting the iteratively updated relationship graph differently for the first and second users so that the iteratively updated relationship graph is presented differently to the first and second users, wherein the adapting the iteratively updated relationship graph differently for the first and second users so that the iteratively updated relationship graph is presented differently to the first and second users includes predicting a linguistic complexity capability of the first user, predicting a linguistic complexity capability of the second user, removing a first node of the relationship graph for presenting the relationship graph to the first user in dependence on the predicted linguistic complexity capability of the first user, removing a second node of the relationship graph for presenting the relationship graph to the second user in dependence on the predicted linguistic complexity capability of the second user, wherein the predicting linguistic complexity capability of the first user includes querying a predictive model that has been trained by machine learning with training data of the first user, the training data including session data of the first user from the prompting data session.

12. The computer implemented method of claim 1, wherein the examining user data of the at least one user includes monitoring a conversation involving first and second users, and wherein the iteratively updating the relationship graph includes (1) detecting a second topic defined by the conversation, and (2) adding a node to the relationship graph for the second topic, wherein the relationship graph presents at a first node of the relationship graph asset data for a first topic detected prior to the detecting the second topic.

13. The computer implemented method of claim 1, wherein the examining user data of the at least one user includes monitoring a conversation involving first and second users, and wherein the iteratively updating the relationship graph includes (1) detecting a second topic defined by the conversation, and (2) adding a second topic definition node to the relationship graph for the second topic, wherein the relationship graph presents at a first topic definition node of the relationship graph asset data for a first topic detected prior to the detecting the second topic, wherein the method includes predicting that the first user has a higher than baseline linguistic complexity capability for the first topic, wherein the method includes predicting that the first user has a lower than baseline linguistic complexity capability for the second topic, wherein the presenting the iteratively updated relationship graph to one or more user includes (i) retaining a certain node of the relationship graph in dependence on the predicted linguistic complexity capability of the first user for the first topic, and (ii) retaining a particular node of the relationship graph in dependence on the predicted linguistic complexity capability of the first user for the first topic, wherein asset data of the certain node has been determined to have a threshold satisfying similarity with asset data of the first topic definition node, wherein asset data of the particular node has been determined to have a threshold satisfying similarity with asset data of the second topic definition node.

14. The computer implemented method of claim 1, wherein the examining user data of the at least one user includes monitoring a conversation involving first and second users, wherein the monitoring includes converting voice based content of the conversation to text, and subjecting the text to natural language processing for topic extraction, wherein the examining user data of the at least one user includes monitoring a conversation involving first and second users, and wherein the presenting the iteratively updated relationship graph to one or more user includes adapting the iteratively updated relationship graph differently for the first and second users so that the iteratively updated relationship graph is presented differently to the first and second users, wherein the adapting the iteratively updated relationship graph differently for the first and second users so that the iteratively updated relationship graph is presented differently to the first and second users includes predicting a linguistic complexity capability of the first user, predicting a linguistic complexity capability of the second user, removing a first node of the relationship graph for presenting the relationship graph to the first user in dependence on the predicted linguistic complexity capability of the first user, removing a second node of the relationship graph for presenting the relationship graph to the second user in dependence on the predicted linguistic complexity capability of the second user, wherein the predicting linguistic complexity capability of the first user includes querying a predictive model that has been trained by machine learning with training data of the first user, the training data including session data of the first user from the prompting data session, wherein the iteratively updating the relationship graph includes (1) detecting a second topic defined by the conversation, and (2) adding a second topic definition node to the relationship graph for the second topic, wherein the relationship graph presents at a first topic definition node of the relationship graph asset data for a first topic detected prior to the detecting the second topic, wherein the method includes predicting that the first user has a higher than baseline linguistic complexity capability for the first topic, wherein the method includes predicting that the first user has a lower than baseline linguistic complexity capability for the second topic, wherein the presenting the iteratively updated relationship graph to one or more user includes (i) retaining a certain node of the relationship graph in dependence on the predicted linguistic complexity capability of the first user for the first topic, and (ii) retaining a particular node of the relationship graph in dependence on the predicted linguistic complexity capability of the first user for the first topic, wherein asset data of the certain node has been determined to have a threshold satisfying similarity with asset data of the first topic definition node, wherein asset data of the particular node has been determined to have a threshold satisfying similarity with asset data of the second topic definition node.

15. The computer implemented method of claim 1, wherein the examining user data of the at least one user includes monitoring a conversation involving first and second users, and wherein the iteratively updating the relationship graph includes (1) detecting a second topic defined by the conversation, and (2) adding a node to the relationship graph for the second topic, wherein the relationship graph presents at a first node of the relationship graph asset data for a first topic detected prior to the detecting the second topic.

16. The computer implemented method of claim 1, wherein the method includes mining data assets defining candidate assets from one or more data source, and generating the relationship graph, wherein the relationship graph includes nodes presenting asset data and edges connecting the nodes, wherein the generating includes employing clustering analysis to identify assets of the candidate assets that are nearest neighbor assets of a topic definitional nodes, and presenting asset data of the nearest neighbor assets and the topic definitional asset in respective nodes of the relationship graph, wherein according to the clustering analysis the candidate assets are analyzed in first and second dimensions, wherein the first dimension is a term strength dimension that considers term usage within the candidate assets, and wherein the second dimension is an engagement dimension that considers historical engagements of asset data of the candidate assets by users when presented on historical relationship graphs.

17. The computer implemented method of claim 1, wherein the presenting the iteratively updated relationship graph to one or more user includes presenting different first and second versions of the iteratively updated relationship graph to first and second users, wherein the method includes during the presenting different first and second versions of the iteratively updated relationship graph (1) monitoring engagement of the first user with the first version, (2) monitoring engagement of the second user with the second version, (3) changing the first version in dependence on the monitoring engagement of the first user with the first version, (4) changing the second version in dependence on the monitoring engagement of the second user with the second version.

18. A computer program product comprising:
a computer readable storage medium readable by one or more processing circuit and storing instructions for execution by one or more processor for performing a method comprising:
examining user data of at least one user to determine whether a criterion has been satisfied for running a prompting data session for prompting the at least one user;
responsively to determining that the criterion has been satisfied for running the prompting data session for prompting the at least one user, running a prompting data session, wherein the running the prompting data session includes (a) establishing and iteratively updating a relationship graph and (b) presenting the iteratively updated relationship graph to one or more user.

19. A system comprising:
a memory;
at least one processor in communication with the memory; and
program instructions executable by one or more processor via the memory to perform a method comprising:
examining user data of at least one user to determine whether a criterion has been satisfied for running a prompting data session for prompting the at least one user;
responsively to determining that the criterion has been satisfied for running the prompting data session for prompting the at least one user, running a prompting data session, wherein the running the prompting data session includes (a) establishing and iteratively updating a relationship graph and (b) presenting the iteratively updated relationship graph to one or more user.

20. The system of claim 19, wherein the presenting the iteratively updated relationship graph to one or more user includes presenting an iterative adapted version of the iteratively updated relationship graph to a first user, wherein the method includes during the presenting the iteratively updated relationship graph (1) monitoring engagement of the first user with the relationship graph, and (2) changing the iterative adapted version to include an asset data presenting node in dependence on the monitoring engagement of the first user indicating that an engagement of the first user with the relationship graph has fallen below a threshold level of engagement, wherein the monitoring engagement of the first user includes monitoring each of (i) whether asset data of the relationship graph configured as a hyperlink has been activated by the first user during a current prompting data session, (ii) a speed which the first user actuated asset data of the relationship graph during the current prompting data session, (iii), force with which the first user has actuated asset data of the relationship graph during the current prompting data session, (iv) whether the first user referenced content of asset data the relationship graph in spoken words of the first user during the current prompting data session, and (v) an eye gaze of the first user on asset data of the relationship graph during the current prompting data session.
